(19) United States
(12) Patent Application Publication
(10) Pub. No.: US 2023/0332704 A1
(43) Pub. Date: Oct. 19, 2023

(54) FLUID VALVE OR HYDRANT

(71) Applicant: Aquor Water Systems, Incorporated, Port Townsend, WA (US)

(72) Inventors: Micah Mutch, Duvall, WA (US); Leif Portmann-Bown, Port Townsend, WA (US); Kamil Slusarski, Port Townsend, WA (US); Richard O. Walcome, Port Townsend, WA (US)

(73) Assignee: Aquor Water Systems, Incorporated, Port Townsend, WA (US)

(21) Appl. No.: 18/303,235

(22) Filed: Apr. 19, 2023

Related U.S. Application Data
(60) Provisional application No. 63/442,102, filed on Jan. 30, 2023.
(60) Provisional application No. 63/332,636, filed on Apr. 19, 2022.

(51) Int. Cl. F16K 17/04; E03B 9/02

(52) U.S. Cl. CPC F16K 17/0466; E03B 9/02; E03B 2009/022

(57) ABSTRACT

An embodiment of a valve, such as a water valve, includes a body, a sleeve, and a rod. The body includes a body cavity, and the sleeve is removably disposable within the body cavity and includes a sleeve cavity. And the rod is movably disposable within the sleeve cavity and is configured to form a fluid-tight seal between the body cavity and the sleeve cavity while the rod is in a closed position and is configured to allow a fluid to flow from the body cavity to the sleeve cavity while the rod is in an open position. Furthermore, one or more components of the valve each can be made partially or fully from one or more polymers.

### CROSS-REFERENCE TO RELATED APPLICATIONS

This application claims benefit of priority to the following U.S. Patent Applications, which are incorporated by reference as if set forth in their entireties: U.S. Patent Application Ser. No. 63/332,636, entitled “POLYMER HYDRANT,” filed on Apr. 19, 2022; and U.S. Patent Application Ser. No. 63/442,102, entitled “HOT/COLD FLUID (E.G., WATER) VALVE,” filed on Jan. 30, 2023.

This application is related to the following U.S. Patent Applications, each of which is incorporated by reference as if set forth in its entirety:

U.S. patent application Ser. No. 15/873,867, entitled “ANTI-FREEZING WATER VALVE WITH OPTIONAL ANTI-SIPHON ASSEMBLY AND WATER-VALVE ACCESSORIES,” filed on Jan. 17, 2018, issued as U.S. Pat. No. 11,242,673; U.S. patent application Ser. No. 15/940,647, entitled “ANTI-FREEZING WATER VALVE CONFIGURED FOR UNDERGROUND (BURIED) USE AND WITH OPTIONAL ANTI-SIPHON ASSEMBLY, AND WATER-VALVE ACCESSORIES,” filed on Mar. 29, 2018, issued as U.S. Pat. No. 11,186,970; and U.S. patent application Ser. No. 15/940,664, entitled “FIRE-SUPPRESSION WATER-INTAKE VALVE, FIRE-SUPPRESSION SPRINKLER HEAD CONFIGURED FOR RAPID INSTALLATION IN, AND RAPID REMOVAL FROM, THE WATER-INTAKE VALVE WITHOUT THE NEED TO INTERRUPT THE WATER SUPPLY, AND RELATED SYSTEMS AND METHODS,” filed Mar. 29, 2018, issued as U.S. Pat. No. 11,542,689.

### SUMMARY

An embodiment of a valve (e.g., a water or other-fluid valve) for installation in a structure (e.g., in an exterior wall of a home or commercial building, in the deck of a boat, or in another edifice or vessel) includes a body, a sleeve, and a rod. The body includes a body cavity, and the sleeve includes a sleeve cavity and is removably disposable within the body cavity. And the rod is movably disposable within the sleeve cavity and is configured to form a fluid-tight seal (e.g., a water-tight seal) between the body cavity and the sleeve cavity while the rod is in a valve-closed position and is configured to allow a fluid (e.g., water) to flow from the body cavity to the sleeve cavity while the rod is in a valve-open position.

Such a valve has one or more advantages as compared to a conventional valve.

For example, when used to dispense water selectively or controllably, because the valve has no integral faucet or spigot, the valve can be mounted flush (or approximately flush) against the side or deck of a structure through which the water valve extends. Such a flush-mounted valve can be aesthetically pleasing and can reduce or eliminate the occurrence or severity of injuries and other damages that may be caused by a person or object bumping into a conventional faucet or spigot. Furthermore, the absence of a faucet or spigot can deter or prevent unauthorized water usage.

Moreover, one or more components of the valve each can be made from one or more polymers, e.g., by injection molding. A polymer-based water valve can have additional advantages compared to a conventional water valve having mostly metal or metal-alloy components. For example, a polymer water valve can be cheaper to manufacture because polymer materials are generally cheaper to produce and to obtain than metals and metal alloys. Also, a polymer water valve provides additional anti-freezing protection that a conventional water valve may be unable to provide because a polymer may have a lower thermal conductivity than a metal. In an embodiment, a water valve includes multiple components composed of polymers, the components configured to provide multiple insulating layers between the interior and the exterior (i.e., exposed portion) of the water valve. The polymer components provide high thermal insulation and may be of shorter lengths than metal anti-freezing water valves. Alternatively, some components located on the exterior of the water valve, such as the faceplate assembly, can be composed of metal to reduce or prevent degradation of the polymer-based components, particularly to protect polymer components that would otherwise be exposed to ultraviolet radiation from the sun.

Moreover, the arrangement or configuration of the components of the valve can provide further advantages over conventional valves. For example, when used to dispense water selectively or controllably, one or more components most likely to wear out or otherwise to fail with use over time can be easily removed, reinstalled, upgraded, and/or re-configured during maintenance without detaching the valve from the structure to which the valve is attached and without disconnecting the valve from the water supply to which the valve is connected.

### BRIEF DESCRIPTION OF THE DRAWINGS

This application contains at least one drawing executed in color. The drawings are provided to the Office along with payment of the necessary fee.

Understanding that the drawings depict only exemplary embodiments and are not therefore to be considered limiting in scope, the exemplary embodiments will be described with additional specificity and detail through the use of the accompanying drawings, as briefly described below and as further described in the detailed description.

FIG. 1 is an isometric view of a water valve with polymer components and a metal faceplate, according to an embodiment.

FIG. 2 is a cutaway side view of the water valve of FIG. 1 in a valve-closed position or configuration, according to an embodiment.

FIG. 3 is an exploded isometric view of the water valve of FIGS. 1-2 and a handle, according to an embodiment.

FIG. 4 is an isometric view of the water valve of FIG. 3 and the handle of FIG. 3 disposed in a receptacle to cause the water valve to be in a valve-open position or configuration, according to an embodiment.

FIG. 5 is a cutaway side view of the water valve of FIG. 4 and of the handle of FIG. 4 causing the water valve to be in a valve-open position or configuration, according to an embodiment.

FIG. 6 is an exploded isometric view of the water valve of FIG. 1, according to an embodiment.

FIG. 7 is an exploded isometric view of a portion of the water valve of FIG. 1 while a body of the water valve is installed in a structure (e.g., a home or other building) and/or connected to a water source (e.g., a water supply of a home or other structure), according to an embodiment.

FIG. 8 is an exploded side view of a portion of the water valve of FIG. 7, according to an embodiment.

FIG. 9 is a front view of the water valve of FIG. 1 installed in an exterior wall of a structure (e.g., a house or other building), according to an embodiment.

FIG. 10A is an isometric view of an on/off valve attachable to the handle of FIGS. 3-5, according to an embodiment.

FIG. 10B is an isometric view of an antisiphon valve attachable to the handle of FIGS. 3-5, according to an embodiment.

FIG. 10C is a rear view of a handle compatible with the water valve of FIGS. 1-5 and 9 and having an on/off valve, according to another embodiment.

FIG. 10D is a cutaway side view of the handle of FIG. 10C, according to an embodiment.

FIG. 11 is an isometric view of a water valve with one or more polymer components and a metal faceplate, according to another embodiment.

FIG. 12 is a cutaway side view of the water valve of FIG. 11 in a valve-closed position or configuration, according to an embodiment.

FIG. 13 is an exploded isometric view of the water valve of FIGS. 11-12 and a handle, according to an embodiment.

FIG. 14 is an isometric view of the water valve of FIG. 13 and the handle of FIG. 13 disposed in a receptacle of the water valve to cause the water valve to be in a valve-open position or configuration, according to an embodiment.

FIG. 15 is a cutaway side view of the water valve of FIG. 14 and of the handle of FIG. 14 causing the water valve to be in an valve-open position or configuration, according to an embodiment.

FIGS. 16A-16B are cutaway side views of an anti-siphon assembly of the water valve of FIGS. 11-15 in anti-siphon-valve-closed and anti-siphon-valve open positions or configurations, respectively, according to an embodiment.

FIG. 17 is an exploded isometric view of the water valve of FIG. 11, according to an embodiment.

FIG. 18 is an exploded isometric view of a portion of the water valve of FIG. 11 while a body of the water valve is installed in a structure (e.g., a home or other building) and/or connected to a water source (e.g., a water supply of a home or other structure), according to an embodiment.

FIG. 19 is a front view of the water valve of FIG. 11 installed in an exterior wall of a structure (e.g., a house or other building), according to an embodiment.

FIG. 20 is a flow diagram of a method for disassembling the water valves of FIG. 1 and FIG. 11, for example while the bodies of the water valves are installed in a structure and/or are connected to a water supply, according to an embodiment.

FIG. 21 is a flow diagram of a method for assembling the water valves of FIG. 1 and FIG. 11, for example while the bodies of the water valves are installed in a structure and/or are connected to a water supply, according to an embodiment.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown, by way of illustration, specific illustrative embodiments. But it is to be understood that other embodiments may be utilized and that logical, mechanical, and electrical changes may be made. The following detailed description is, therefore, not to be taken in a limiting sense.

Further in the following description, “approximate,” “approximately,” “about,” and “substantially,” mean that a quantity (e.g., a length) can vary from a given value (e.g., 10 feet) by up to ±20% (e.g., ±20% of 10 feet=±1 foot, which means an “approximate” value of 10 feet can range from 10−1=9 feet to 10+1=11 feet).

Some water-distribution systems include one or more water valves that are configured to distribute or dispense water for personal use, recreational use, or other uses. These water valves may be installed in the exterior or interior of various structures such as in the interior or exterior walls of homes, buildings, or other edifices, or in the decks, floors, or walls of boats or other vessels.

Some conventional water valves are composed entirely of metals or metallic materials. These materials are durable and, hence, metallic water valves may last for several years or even decades after installation. However, metallic materials, in general, have high thermal conductivity, and, therefore, typically rapidly dissipate heat across an interface or into the surrounding environment. While high thermal conductivity may be suitable or even advantageous for some applications, conventional water valves with high-thermal-conducting components risk damage and inoperability due to the freezing of the components of the water valve. And such a conventional water valve installed in an exterior wall of a structure may allow freezing of a connected water line by inadequately insulating the water line from the exterior environment (e.g., the outdoors in wintertime). Furthermore, metal components used to assemble conventional water valves can be expensive and burdensome to install, to re-install, repair, upgrade, and otherwise to maintain.

Moreover, many conventional valves, such as water valves, are not serviceable, or are only partially serviceable, after they are installed, for example, after they are plumbed into a building's water supply.

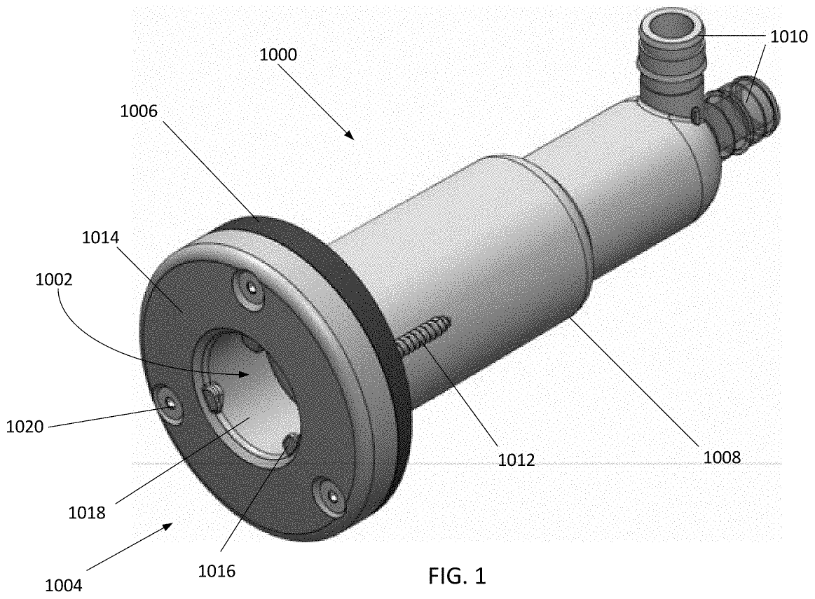

Referring to FIG. 1, a fluid valve (or hydrant) 1000 is configured to distribute or to dispense, selectively, a fluid, such as water, from a structure's fluid (e.g., water) system or supply out through a receptacle 1002, according to an embodiment. In more detail, the valve 1000 is configured to dispense the fluid by opening to allow the fluid to flow from a fluid conduit (e.g., a pipe) of the structure's water supply, through the valve, and out through the receptacle 1002 in response to one inserting a valve-opening-and-fluid-dispensing device (not shown in FIG. 1) into the receptacle. Hereinafter, the valve 1000 is referred to as a water valve, the valve-opening-and-fluid-dispensing device is referred to and (pedagogically described) as a water handle, and the fluid is referred to as water, it being understood that the fluid can be a fluid other than water, and the valve 1000 and the water handle can be configured to dispense a fluid other than water.

In addition to the receptacle 1002, the water valve 1000 includes a faceplate assembly 1004, a wedge 1006, a valve or hydrant body 1008 including a fluid inlet 1010, and mounting screws 1012 (only one mounting screw visible in FIG. 1).

The faceplate assembly 1004 includes a faceplate 1014, which includes the receptacle 1002, protrusions 1016, and a flange 1018, and machine screws 1020. After the valve 1000 is installed in a building or other structure, the faceplate 1012 (and possibly the wedge 1006) may be the only components of the valve exposed to sunlight. Therefore, the faceplate 1012 (and possibly the wedge 1006) can be made from a material (e.g., a metal or metal alloy) suitable to shield itself, the wedge 1006, and the other components of the valve 1000 from sunlight, particularly from ultraviolet (UV) rays that may otherwise damage (e.g., discolor, weaken), over time, the faceplate, wedge, or one or more of the other valve components.

The wedge 1006 is configured to cause the valve 1000 to be canted downward at an angle (e.g., approximately 5°) so that water remaining inside of the valve after the water handle is removed can drain naturally through the receptacle 1002 to prevent the remaining water from pooling, and possibly freezing, inside of the valve. The wedge 1006 may be formed from a suitable material such as a polymer, foam, or rubber, or the wedge, like the faceplate 1014, may be formed from a material (e.g., a metal or metal alloy) suitable to shield itself and one or more other components of the valve 1000 from sunlight, particularly from the (UV) rays contained within sunlight. For example, the wedge 1006 may be formed from a foam that is resistant to UV damage.

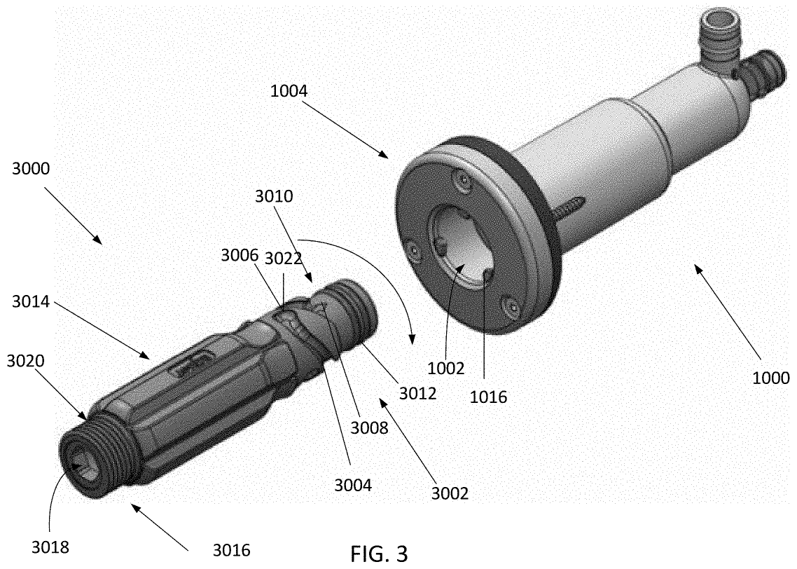

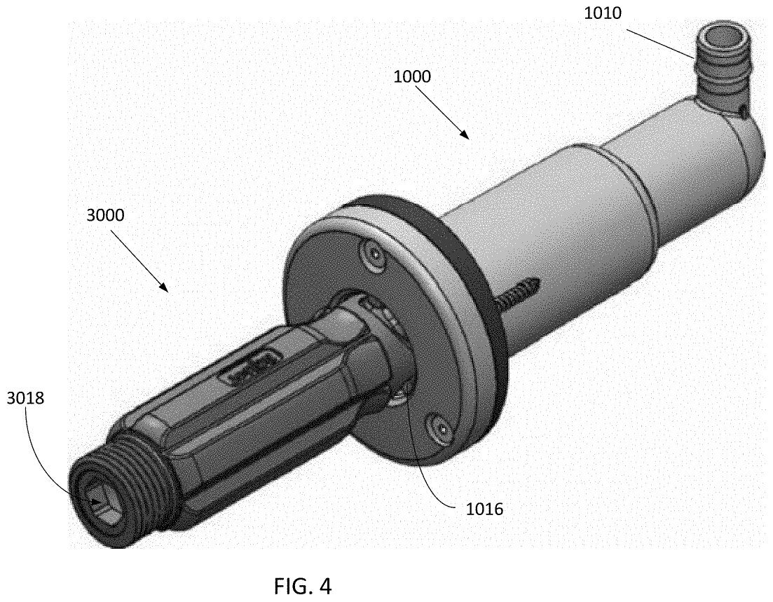

The protrusions 1016 are configured to engage, and to secure within the receptacle 1002, a water handle as described below in conjunction with FIGS. 3-4.

The flange 1018 is configured to be inserted into the valve body 1008, and, therefore, to stably engage the faceplate 1014 with the body. Furthermore, the flange 1018 can be configured to protect internal components of the valve 1000 from one or more UV components of sunshine.

And the machine screws 1020 are configured not only to fasten the faceplate 1014 to the valve body 1008, but to hold internal valve components inside of the valve body, i.e., to hold the valve 1000 together.

The valve body 1008 is configured to house the valve components other than the faceplate assembly 1004 (but for a portion of the flange 1018), the wedge 1006, and the mounting screws 1012.

The inlet 1010 is configured to allow the valve 1000 to be connected to a water supply, or to another water source, of a structure (e.g., a house, a commercial building) in which the valve is installed. For example, one can slide a conduit, such as PEX piping, over the inlet 1010 and can form, conventionally, a water-tight connection (e.g., a crimp connection or a shark-bite connection) between the conduit and inlet. Furthermore, the inlet can extend approximately 90° relative to the body 1008 in any suitable circumferential position from 0°-360° (as indicated by the solid instance of the inlet) or can extend approximately straight out the back of the body at a relative angle of approximately 0° (as indicated by the phantom instance of the inlet).

And the mounting screws 1012 are configured to mount the body 1008, and, therefore, the entire valve 1000, to a structure, such as a home or commercial building, in which the valve 1000 is installed. For example, the mounting screws 1012 can be configured to engage a wall stud of a home or other building.

In addition to the relatively low cost of the valve 1000 due one or more components of the valve being made from one or more polymers, as described in more detail below, the valve is designed so that one or more components besides the valve body 1008 can be replaced, repaired, reinstalled, or upgraded without first uninstalling the valve, for example without first detaching the valve body from a structure in which the valve is installed and without first disconnecting the valve from a water source.

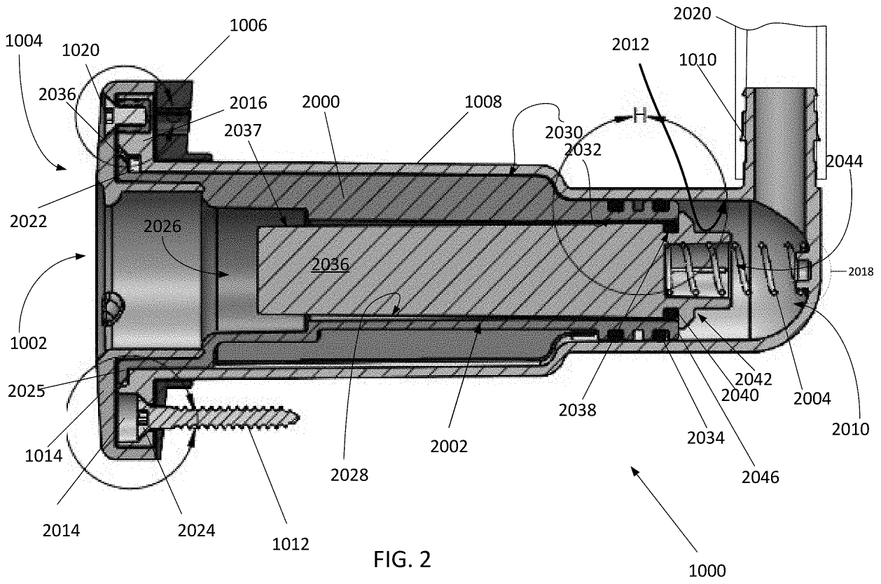

FIG. 2 is a cutaway side view of the valve 1000 of FIG. 1, according to an embodiment.

In addition to the faceplate assembly 1004, the wedge 1006, the body 1008, and the mounting screws 1012, the valve 1000 includes a sleeve 2000, a flow-control rod 2002, and a rod-return spring 2004.

The body 1008 includes a body cavity 2010 having an inner body-cavity wall or inner body-cavity surface 2012, countersink holes 2014, a flange 2016, a spring holder 2018, and the valve inlet 1010 configured for connection to a water supply via a conduit 2020 (the conduit may or may not be considered to be part of the valve 1000). The body 1008 also may include sleeve-removal slots 2022, which are described further below. The countersink holes 2014 are configured to receive heads 2024 of the mounting screws 2012 so that the heads do not interfere with the faceplate 1014 and a sleeve flange 2025 mounting flush against the body flange 2016, which is configured to limit the distance that the sleeve 2000 can be inserted inside of the body cavity 2010 and to provide a portion of the body configured to receive the machine screws 1020. And the spring holder 2018 maintains the rod-return spring 2004 stably aligned with the flow-control rod 2002.

The sleeve 2000 is configured to fit inside of the body cavity 2010 of the body 1008 and to be held in place by the faceplate assembly 1004, but also is configured for removal from the body cavity to allow replacement, repair, re-installation, or upgrade of itself or of other internal valve components such as the rod 2002 and the spring 2004. In addition to the sleeve flange 2025, the sleeve 2000 includes a sleeve cavity 2026 having an inner cavity wall or inner cavity surface 2028, an outer sleeve wall or outer sleeve surface 2030, one or more sleeve-seal seats 2032 formed in the outer sleeve surface, and one or more sleeve seals 2034 disposed in the sleeve-seal seats. The sleeve seals 2034 are configured to form a fluid-tight seal (e.g., a water-tight seal) between the inner wall 2012 of the body cavity 2010 and the outer sleeve surface 2030 while the sleeve 2000 is property installed inside of the body cavity. For example, the one or more sleeve seals 2034 may be conventional O-rings. Because there may be a suction (caused, e.g., by the sleeve seal(s) 2034) that hinders removal of the sleeve 2000 from the body cavity 2010 while the valve inlet 1010 is connected to the conduit 2020, the sleeve may include one or more sleeve-access slots 2036 configured to provide access to the sleeve-removal slots 2022, which are configured to receive a pry tool, such as the blade of a screw driver, to allow one to pry the sleeve 2000 out of the body cavity 2010. For example, there may be two sleeve-removal slots 2022 and two corresponding sleeve-access slots 2036 spaced approximately 180° apart so that one can simultaneously apply a prying force to the sleeve 2000 from both slots with, for example, two flat-blade screwdrivers.

The flow-control rod 2002 is configured for slidable disposition within the sleeve cavity 2026 to control a flow of water from the structure water supply, through the conduit 2020, the inlet 1010, the body cavity 2010, and the sleeve cavity, and out from the receptacle 1002 (and through a water handle not shown in FIG. 2). The flow-control rod 2002 includes a shaft 2036 having an outer surface 2037, a rod-seal seat 2038, a rod seal 2040 (e.g., a conventional O-ring) disposed in the rod-seal seat, a rod flange 2042 configured to limit the distance that the flow-control rod can travel toward the receptacle 1002, and a spring receptacle 2044 configured to receive the spring 2004.

Still referring to FIG. 2, the valve 1000 is shown in a valve-closed position or state, that is, a state in which the flow-control rod 2002 is configured to, and does, prohibit water from flowing from the body cavity 2010 to the sleeve cavity 2026. In the valve-closed state, the water pressure from the connected water supply is present in the body cavity 2010 via the conduit 2020 and the inlet 1010, and the spring 2004 is in a compressed state. The water pressure and the compressed spring 2004 act in concert to urge the flow-control rod 2002 away from a rear of the body cavity 2010—the rear of the body cavity is where the spring holder 2018 is located—and toward the receptacle 1002. Consequently, the water pressure and the compressed spring 2004 force the rod seal 2040 into the sleeve cavity 2026 such that the rod seal forms a water-tight seal between the inner surface 2028 of the sleeve cavity 2026 and the outer surface 2037 of the flow-control rod 2002; the rod flange 2042 prevents the water pressure and the compressed spring 2004 from pushing the flow-control rod out of the valve 1000 through the receptacle 1002. In an alternate embodiment, instead of being sized to form a water-tight seal between the sleeve-cavity inner surface 2028 and the rod outer surface 2037, the rod seal 2040 can have a larger diameter such that the rod seal forms a water-tight seal between the body cavity 2010 and an end 2046 of the sleeve 2000. Or the flow-control rod 2022 can have multiple rod seals 2040, one or more rod seals that are configured to form a water-tight seal between the sleeve-cavity inner surface 2028 and the rod outer surface 2037, and another rod seal that is configured to form a water-tight seal between the body cavity 2010 and the sleeve end 2046.

FIG. 3 is an exploded isometric view of the water valve 1000 of FIGS. 1-2 and of a valve-opening-and-water-dispensing device (pedagogically described as a “water handle”) 3000, according to an embodiment. As described below, one can use the water handle 3000 to open the valve 1000 and to dispense water therefrom.

The handle 3000 includes a rear end 3002 having spiral grooves 3004 each with an end well 3006, and one or more alignment arrows 3008, the spiral grooves being configured to engage the protrusions 1016 of the faceplate assembly 1004 to facilitate one inserting the handle into the valve receptacle 1002 to open the valve 1000. The rear end 3002 of the handle 3000 also includes one or more handle seal seats 3010 and one or more handle seals 3012 disposed in the one or more handle seats. For example, the handle 3000 includes two seats 3010 and two seals 3012, which are configured to limit or prevent splash back when one removes the handle from the valve 1000 to close the valve.

In addition to the rear end 3002, the handle 3000 includes a grasping section 3014 and a front end 3016. The grasping section 3014 is configured to allow one to grasp the handle 3000 and to rotate the handle to open or close the valve 1000. And the front end includes a dispensing port 3018 and is configured (e.g., with threads 3020) to allow one to attach a conduit (not shown in FIG. 3), such as a garden hose, to the handle 3000.

FIG. 4 is an isometric view of the water handle 3000 inserted or disposed in the water valve 1000, thus causing the valve to be in an open configuration or state in which the water valve dispenses water from a water supply (not shown in FIG. 4) connected to the inlet 1010 out through the dispensing port 3018 of the water handle 3000.

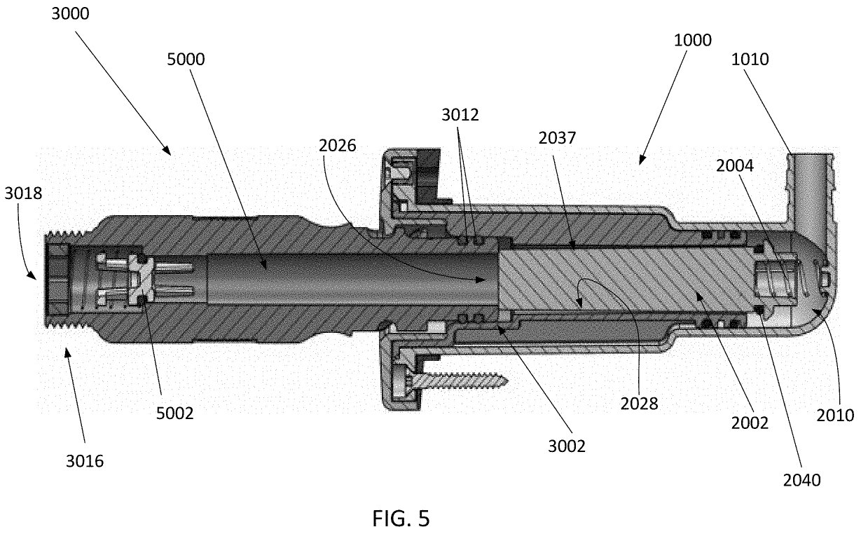

FIG. 5 is a cutaway side view of the water valve 1000 and the inserted handle 3000 of FIG. 4, where the inserted handle causes the water valve to be in an open state or configuration, according to an embodiment. The inserted handle 3000 forces the flow-control rod 2002 toward the rear of the body cavity 2010 and, therefore, forces the rod seal 2040 out from the sleeve cavity 2026. The seal 2040 being forced out of the sleeve cavity 2026 breaks the water-tight seal that the rod seal 2040 previously formed between the inner surface 2028 of the sleeve cavity 2026 and the outer surface 2037 of the rod 2002, thus allowing water to flow from the water supply (not shown in FIG. 5) via the conduit 2020 (FIG. 2) and the inlet 1010, into the body cavity 2010, and out from the dispensing port 3018 of the handle 3000 via the sleeve cavity 2026 and a handle cavity 5000 within the handle 3000.

The handle 3000 also includes a check valve 5002 configured to allow water to flow in a direction from the sleeve cavity 2026 to the dispensing port 3018 but to prohibit water from flowing in the opposite direction. A function of the check valve 5002 is to prevent water from a hose or other conduit (not shown in FIG. 5) coupled to the rear end 3016 of the water handle 3000 from squirting out the front end 3002 of the water handle when one removes the water handle from the valve 1000.

Referring to FIGS. 2-5, the opening and closing of the water valve 1000 is described, according to an embodiment.

First, a user (not shown in FIGS. 2-5) grasps the water handle 3000 around the grasping section 3014.

Next, the user aligns the alignment arrow 3008 with one of the protrusions 1016.

Then, the user inserts the water handle 3000 into the receptacle 1002 until he encounters resistance.

Next, while continuing to push the water handle into the receptacle 1002, the user rotates the water handle 3000 in a clockwise direction. As the user so rotates the handle 3000, the protrusions 1016 and the grooves 3004 interact to convert the rotational torque being exerted by the user into a linear force that forces the handle 3000 further into the receptacle 1002, then into the sleeve cavity 2026 and against the flow-control rod 2002.

Then, as the user continues to rotate the water handle 3000 in a clockwise direction, the protrusions 1016 and the grooves 3004 continue to interact to convert the rotational torque being exerted by the user into a linear force that overcomes the opposite force being exerted by the combination of the compressing spring 2004 and the water pressure in the body cavity 2010 and, therefore, that causes the handle to push the flow-control rod 2002 toward the rear of the body cavity 2010. Eventually, the handle 3000 pushes the flow-control rod 2002 far enough toward the rear of the body cavity 2010 that the rod seal 2040 slide out of the sleeve cavity 2026, thus breaking the water-tight seal between the inner surface 2028 of the sleeve cavity 2026 and the outer surface 2037 of the rod 2002.

After the handle 3000 is inserted far enough into the sleeve cavity 2026 to break the water-tight seal between the seal-cavity inner surface 2028 and the rod outer surface 2037, water flows from water supply (not shown in FIGS. 3-5), through the conduit 2020 (FIG. 2) and the inlet 1010 and into the body cavity 2010, from the body cavity into the sleeve cavity 2026, from the sleeve cavity into the handle cavity 5000, and from the handle cavity out from the handle dispensing port 3018—the pressure of generated by the water flow is sufficient to open the check valve 5002.

The user then continues to rotate the handle 3000 in a clockwise direction until the protrusions 1016 engage the end wells 3006 of the grooves 3004, which end wells are configured such that the protrusions, when engaging the end wells, hold the handle stably within the open valve 1000 even after the user removes his hand from the gripping section 3014 (or any other portion) of the handle. After the user releases the handle 3000, the combined force of the water pressure and the compressed spring 2004 against the flow-control rod 2002 pushes the handle 3000 back out from the sleeve cavity 2026 slightly, thus causing each of the protrusions 1016 to “lock” into a respective notch 3022 formed in a front portion of each end well 3006. This locking action holds the handle 3000 stably within the receptacle 1002 even in the presence of a relatively high-pressure water flow out from the dispensing port 3018. In an embodiment, the end wells 3006 and the notches 3022 are configured such that over a range of water pressures typically exerted by water sourced from a municipal water supply, the higher the water pressure the more forcefully and stably the handle 3000 is held within the receptacle 1002.

Still referring to FIGS. 2-5, to close the valve 3000, a user grasps the grasping section 3014 of the handle 3000, pushes the handle slightly further into the receptacle 1002 to disengage the protrusions 1016 from the end-well notches 3022, and rotates the handle in a counterclockwise direction.

As the user so rotates the handle 3000, the protrusions 1016 and the grooves 3004 interact to convert the rotational torque being exerted by the user into a linear force that forces the handle out from the sleeve cavity 2026. The water pressure and the decompressing spring 2004 urge the rod 2002 against the handle 3000, adding to the linear force being generated by the protrusions 1016 and the grooves 3004 and, therefore, making the removal of the handle from the valve 1000 somewhat easier for the user than the insertion of the handle into the valve.

As the user continues to rotate the handle 3000 in the counterclockwise direction, the rod seal 2040 re-enters the sleeve cavity 2026 and re-establishes the water-tight seal between the inner surface 2028 of the sleeve cavity and the outer surface 2037 of the rod 2002.

As the user further continues to rotate the handle 3000 in the counterclockwise direction, the rod flange 2042 contacts the end 2046 of the sleeve 2000 and acts to prevent the flow-control rod 2002 from moving any further toward the receptacle 1002; consequently, from this point forward, the linear force urging the handle 3000 out of the receptacle 1002 is generated entirely by the interaction of the protrusions 1016 and the grooves 3004 as the user continues to rotate the handle in the counterclockwise direction.

And the user continues to rotate the handle 3000 in the counterclockwise direction until the grooves 3004 completely disengage from the protrusions 1016, at which point the user pulls the handle all the way out from the receptacle 1002.

As described above, the dual handle seals 3012 are configured to, and do, prevent pressurized water inside of the sleeve cavity 2026 from leaking around the sides of the handle front end 3002 and splashing, or otherwise wetting, the user while the user is removing the handle from the valve 1000. Furthermore, around the time that the rod seal 2040 re-establishes the water-tight seal between the sleeve-cavity surface 2028 and the rod surface 2037, the check valve 5002 closes to prevent back pressure in a hose or other item (not shown in FIGS. 2-5) attached to the handle rear end 3016 from causing water to squirt through the handle cavity 5000 and out from the handle front 3002 and possibly wet the user.

Descriptions of a valve similar to the valve 1000, and of the methods for opening and closing such a valve, are included in U.S. Pat. No. 11,242,673, which is incorporated by reference.

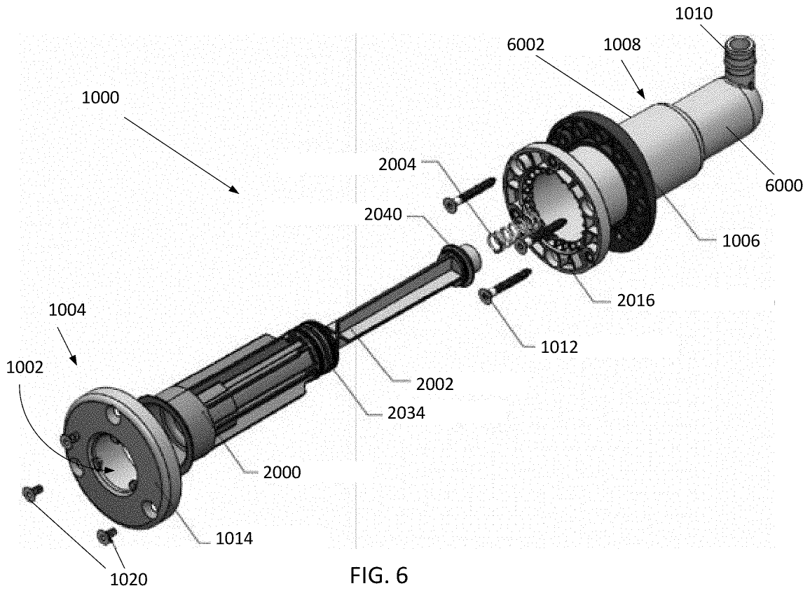

FIG. 6 is an exploded isometric view of the water valve 1000 of FIGS. 1-5, according to an embodiment. Because the faceplate assembly 1004 and the sleeve 2000 can be removed from the body 1008, all of the other (internal) components of the valve 1000, including the sleeve, the sleeve seal(s) 2034, the flow-control rod 2002, the rod seal(s) 2040, and the spring 2004 also can be removed from the valve body for repair, replacement, or upgrading without removing or detaching the valve body from the structure in which the valve body is installed, and without disconnecting, from the inlet 1010, the water supply to which the valve body is connected. That is, there is no need to remove the mounting screws 1012 or to uncouple the conduit 2020 (FIG. 2) from the inlet 1010 to repair or upgrade the components of the valve 1000 other than the body 1008 or the wedge 1006. And in an alternate embodiment, the wedge 1006 may have a cut in it so that it also can be replaced (by pulling apart the wedge at the cut and slipping the wedge over the valve body 1008) while the valve body remains installed in a structure. Furthermore, one or more of the mounting screws 1012 can be repaired, upgraded, or replaced without removing the valve body 1008 from the structure and without uncoupling the conduit 2020 from the inlet 1010. And to perform such a repair, upgrade, or replacement of components, typically it is recommended that the water supply be disconnected (e.g., with an in-line water shut off) from the valve 1000 before the faceplate the faceplate mounting screws 1020 are removed, although disconnecting the water supply is not required to effect repair, upgrade, or replacement of the valve components.

Still referring to FIG. 6, a thinner portion 6000 of the valve body 1008 can be made to any length suitable for the application. For example, the length of the portion 6000 can be made to accommodate the expected thickness of a wall, deck, or other structure portion through which the valve 1000 is to be installed. And no matter the length of the portion 6000, a thicker portion 6002 of the valve body 1008, which thicker portion is configured to receive the sleeve 2000, can have a uniform length regardless of the length of the portion 6000 so that only one length of the sleeve need be manufactured, thus reducing manufacture costs as compared to manufacturing multiple lengths of the thicker portion 6002 and multiple lengths of the sleeve (although different-length springs 2004 may be needed). And in another embodiment, instead of offering thinner valve-body portions 6000 in multiple lengths, the thinner valve-body portion can have a uniform length from valve 1000 to valve 1000, the inlet 1010 can be configured to stick straight out, or approximately straight out, from the back of the body 1008, and the valve can accommodate any wall thickness because one need only insert, into the wall, a section of conduit (e.g., PEX, not shown in FIG. 6) long enough to reach the inlet 1010, whether the inlet be inside or outside of the wall.

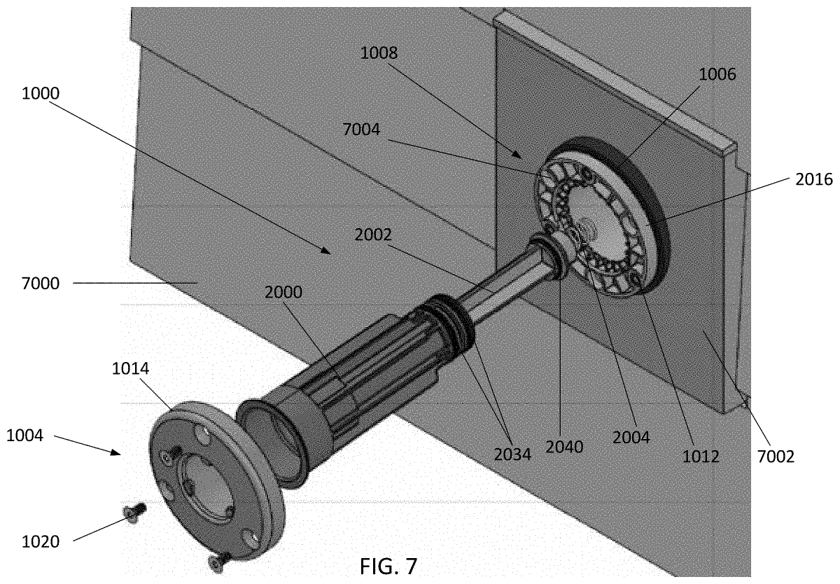

FIG. 7 is an exploded isometric view of a portion of the water valve 1000 of FIGS. 1-6 while the body 1008 of the water valve is installed in an exterior wall 7000 of a structure (e.g., a home, a commercial building, or another building or structure), according to an embodiment. Like FIG. 6, FIG. 7 shows that components of the water valve 1000 other than the valve body 1008 and possibly the wedge 1006 can be replaced, upgraded, or repaired without removing the valve body from the structure 7000 and without disconnecting the inlet 1010 (FIG. 6) from a water supply of, or otherwise associated with, the structure. A mounting block 7002 may be used to facilitate installing of the valve 1000 in the exterior wall 7000. For example, the mounting block 7002 may cover, in an aesthetically pleasing manner, a hole (not shown in FIG. 7) formed in the wall 7000 to receive the valve 1000. Furthermore, the valve 1000 can be installed in a portion of a structure other than an exterior wall of a building. For example, the valve 1000 can be installed in an interior wall, ceiling, or floor of a building, in a deck or other portion of a boat or other vessel, in the ground, or can be embedded in a material such as concrete without the need for wrapping the valve. Moreover, the flange 2016 of the valve body 1008 includes multiple sets of holes 7004 for the mounting screws 1012 so that one can mount the valve in one of many of radial orientation angles. The ability to mount the valve 1000 in one of may orientation angles can be of particular importance when the inlet 1018 extends 90°, or approximately 90°, from the valve body 1008 as shown in solid drawing in FIG. 1

Still referring to FIG. 7, a valve 1000 repair-upgrade-replacement kit can include the seals 2034 and 2040, according to an embodiment. In another embodiment, the kit also can include the rod 2002 and the spring 2004. In still another embodiment, the kit also can include the sleeve 2000. In yet another embodiment, the kit also can include one or more components of the faceplate assembly 1004, such as the mounting screws 1020 and the faceplate 1014. And in still yet another embodiment, the kit also can include one or more mounting screws 1012.

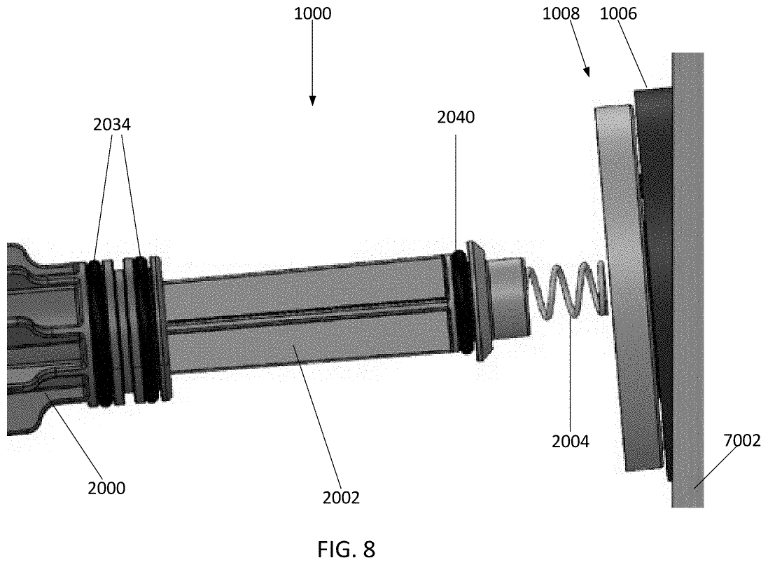

FIG. 8 is an exploded side view of a portion of the water valve 1000 of FIGS. 1-7, according to an embodiment. The view in FIG. 8 demonstrates how the wedge 1006 angles the valve body 1008 relative to a surface of the mounting block 7002, and, therefore, relative to a surface of a wall or other structure portion in, or through, which the valve 1000 is installed, so that after the water handle 3000 (FIG. 3) is removed from the receptacle 1002 (FIG. 3), any water remaining in the body cavity 2010 (FIG. 5) can drain out from the receptacle by the force of gravity to prevent standing water that otherwise could freeze inside of, and, therefore, possibly damage, the valve.

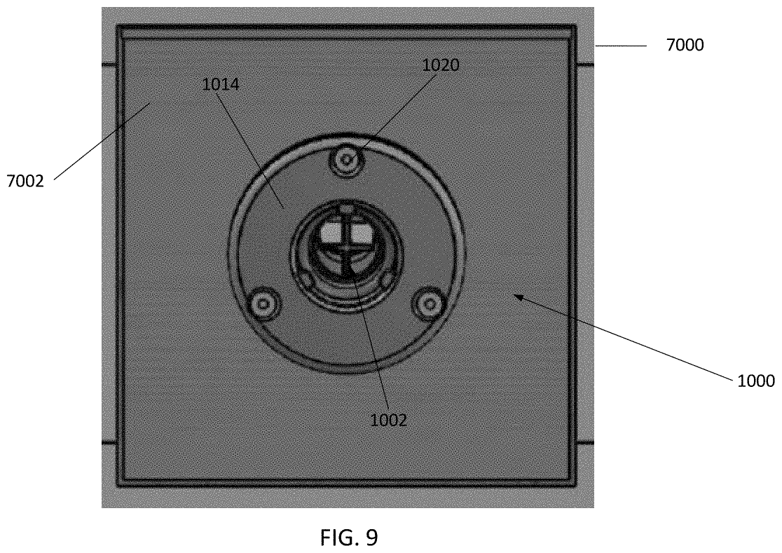

FIG. 9 is a front view of the water valve 1000 of FIGS. 1-8 installed in an exterior wall 7000 of a structure (e.g., a house or other building) with the mounting block 7002, according to an embodiment.

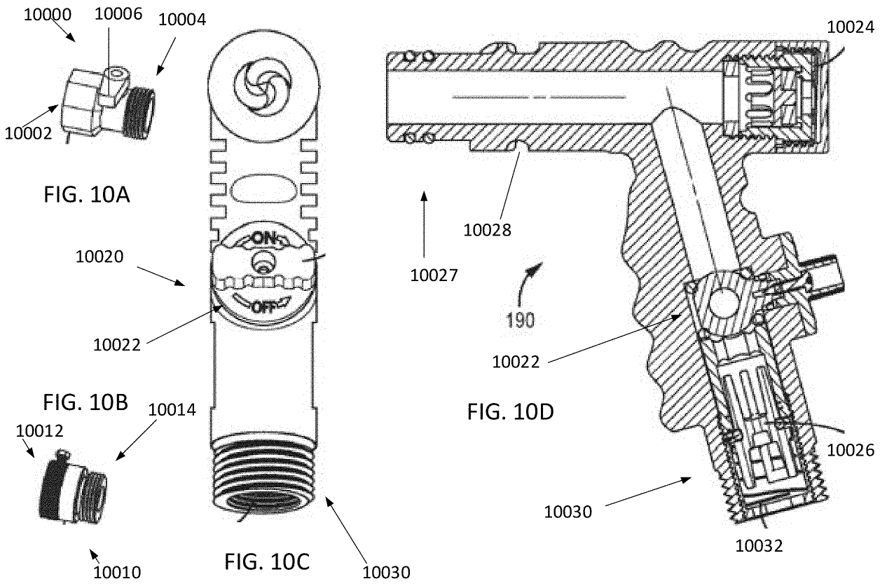

FIG. 10A is an isometric view of an on/off valve 10000 attachable between the handle 3000 of FIGS. 3-5 and a conduit, such as a garden hose (not shown in FIG. 10A), according to an embodiment. The on/off valve 10000 has an end 10002 configured for coupling (e.g., a threaded coupling) to the rear end 3016 of the handle 3000 and has another end 10004 configured for coupling (e.g., a threaded coupling) to the conduit. The on/off valve 10000 functions to allow one to turn “on” (valve switch 10006 open) and “off” (valve switch closed) the water from the valve 1000 (FIGS. 1-9) and the handle 3000 to the connected conduit without connecting and disconnecting the water handle from the valve 1000. Optionally, the water handle 3000 can incorporate the on/off valve 10000 or can incorporate a similar valve.

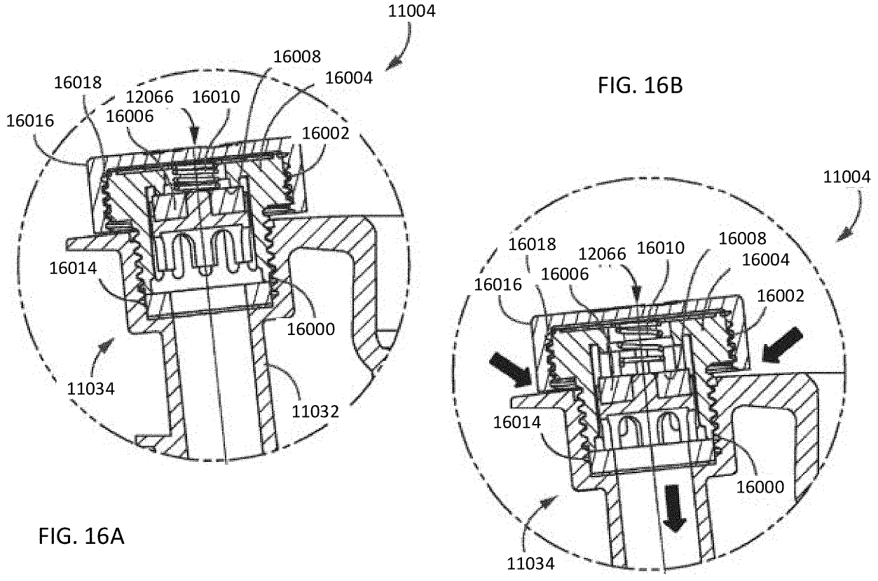

FIG. 10B is an isometric view of a vacuum breaker (also called an antisiphon valve) 10010 attachable between the handle 3000 of FIGS. 3-5 and a conduit such as a garden hose (not shown in FIG. 10A), according to an embodiment. The vacuum breaker 10010 has an end 10012 configured for coupling (e.g., a threaded coupling) to the rear end 3016 of the handle 3000 and has another end 10014 configured for coupling (e.g., a threaded coupling) to the conduit. The vacuum breaker 10010 is configured to compensate for a sudden and momentary pressure drop in the water-supply-and-distribution system to which the water valve 1000 (FIGS. 1-5) is connected. The vacuum breaker 10010 can have a structure similar to the structure of the anti-siphon assembly described below in conjunction with FIGS. 16A-16B and can be configured to operate in a manner similar to the manner in which the anti-siphon assembly operates as described in conjunction with FIGS. 16A-16B. For example, the vacuum breaker 10010 can include the anti-siphon valve assembly of FIGS. 16A-16B. Or the vacuum breaker 10010 can have a structure different than the structure of the anti-siphon assembly of FIGS. 16A-16B and can be configured to operate in a manner different than the manner in which the anti-siphon assembly operates.

FIG. 10C is a rear view of a spigot 10020 compatible with the water valve 1000 of FIGS. 1-5 and 9 and having an on/off valve 10022, an anti-siphon assembly 10024, and a check valve 10026, and FIG. 10D is a cutaway side view of the handle of FIG. 10C, according to an embodiment. Other than including the on/off valve 10022, the anti-siphon assembly 10024, and the check-valve 10026 and having a two-section design, the spigot 10020 is otherwise similar in configuration and operation to the water handle 3000 of FIGS. 3-5. For example, the spigot 10020 has a front end 10027 with grooves 10028 configured to engage the protrusions 1016 (FIG. 3) and has a rear end 10030 configured to couple the spigot to a conduit such as a garden hose. The anti-siphon assembly 10024 can be similar in configuration and operation to the anti-siphon assembly described below in conjunction with FIGS. 16A-16B. The check-valve 10026 can be any conventional and suitable type of check-valve assembly or check valve, is configured to allow water to flow in only one direction, from the water valve 1000 (FIGS. 1-5) out through a dispensing port 10032; for example, the check-valve assembly may be the same as, similar to, or include, the check valve 5002 of FIG. 5. The check-valve assembly 10026 is configured to prevent back flow that might otherwise occur in response to a drop in water pressure within the water-supply-and-distribution system to which the water valve 1000 is connected. In an alternative embodiment, the spigot 10020 includes one, but not both, of the anti-siphon assembly 10024 and check-valve assembly 10026. Including one or both of the anti-siphon assembly 10024 and the check-valve assembly 10026 can render the spigot 10020 suitable for use with a water valve (such as the water valve 1000) that includes no anti-siphon assembly. For example, if the building code of a municipality requires that a structure's water-supply-and-distribution system include anti-siphon functionality, the water spigot 10020 can render the water-supply-and-distribution system building-code compliant even if used with a water valve (such as the water valve 1000) that includes no anti-siphon assembly.

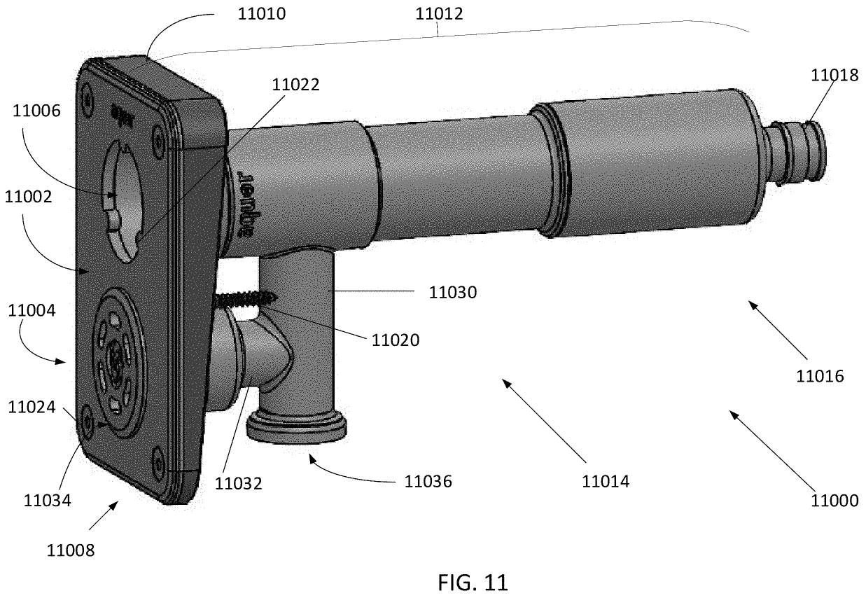

FIG. 11 is an isometric view of a fluid valve (or hydrant) 11000 with one or more polymer components and a polymer or metal faceplate 11002, according to another embodiment in which the water valve also can include an optional anti-siphon assembly 11004. In an embodiment, the structure and operation of the valve 11000 are similar to the structure and operation of the fluid valve 1000 of FIGS. 1-9.

Like the fluid valve 1000 of FIGS. 1-9, the fluid valve 11000 is configured to distribute or to dispense, selectively, a fluid such as water from a structure's water system or supply out through a receptacle 11006, according to an embodiment. In more detail, the valve 11000 is configured to dispense the fluid by opening to allow the fluid to flow from a fluid conduit (e.g., a pipe) of the structure's water supply, through the valve, and out through the receptacle 11006 in response to one inserting a valve-opening-and-fluid-dispensing device like the handle 3000 of FIGS. 3-5 or the handle 10020 of FIGS. 10C-10D into the receptacle. Hereinafter, the valve 11000 is referred to as a water valve, the valve-opening-and-fluid-dispensing device is referred to and (pedagogically described) as a water handle, and the fluid is referred to as water, it being understood that the fluid can be a fluid other than water, and the valve can be configured to dispense a fluid other than water.

In addition to the receptacle 11006, the water valve 11000 includes a faceplate assembly 11008 (which includes the faceplate 11002), a wedge 11010, a valve or hydrant body 11012 having a front portion 11014 and having a rear portion 11016 including a fluid inlet 11018, and mounting screws 11020 (only one mounting screw visible in FIG. 11).

In addition to the faceplate 11002, which includes the receptacle 11006 and an opening to accommodate the anti-siphon assembly 11004, the faceplate assembly 11008 includes protrusions 11022, and machine screws 11024. After the valve 11000 is installed, the faceplate 11002 (and possibly the wedge 11010) may be the only components of the valve exposed to sunlight. Therefore, the faceplate 11002 (and possibly the wedge 11010) can be made from a material (e.g., a metal or metal alloy) suitable to shield itself, the wedge 11010, and the other components of the valve 11000 from sunlight, particular ultraviolet (UV) rays from the sun, which rays may otherwise damage (e.g., discolor, weaken), over time, the faceplate, wedge, or one or more of the other valve components.

The wedge 11010 is configured to cause the valve 11000 to be canted downward at an angle (e.g., approximately 5°-10°) so that water remaining inside of the valve after the water handle is removed can drain naturally through the receptacle 11006 to prevent the remaining water from pooling, and possibly freezing, inside of the valve, and, therefore, to prevent potential damage to the valve or connected water supply that such freezing may cause. The wedge 11010 may be formed from a suitable material such as a polymer, foam, or rubber, or the wedge, like the faceplate 11002, may be formed from a UV-damage-resistant material (e.g., a metal or metal alloy) suitable to shield itself and other components of the valve 11000 from sunlight, particularly from the UV rays contained within sunlight. For example, the wedge 11010 may be formed from a foam that is resistant to UV damage.

The protrusions 11022, which may be similar to the protrusions 1016 of FIG. 1, are configured to engage, and to secure within the receptacle 11006, a water handle such as the water handle 3000 of FIGS. 2-5.

The machine screws 11024 are configured to fasten the faceplate 11002 to the front portion 11014 of the valve body 11012.

The valve body 11012 is configured to house the valve components other than the antisiphon assembly 11004, the faceplate assembly 11008, the wedge 11010, and the mounting screws 11020.

The inlet 11018 is configured to allow the valve 11000 to be connected to a water supply, or other water source, of a structure (e.g., a house, a commercial building) in which the valve is installed. For example, one can slide a conduit, such as PEX piping, over the inlet 11018 and can form, conventionally, a water-tight connection (e.g., a crimp connection or shark-bite connection) between the conduit and inlet. Furthermore, the inlet can extend approximately straight out the rear portion 11016 of the body 11012 at a relative angle of approximately 0° as shown in FIG. 11, or can extend approximately 90° relative to the rear portion of the body in any suitable circumferential position from 0°-360°.

The mounting screws 11020 are configured to mount the body 11012, and, therefore, the entire valve 11000, to a structure, such as a home or commercial building, in which the valve 11000 is installed.

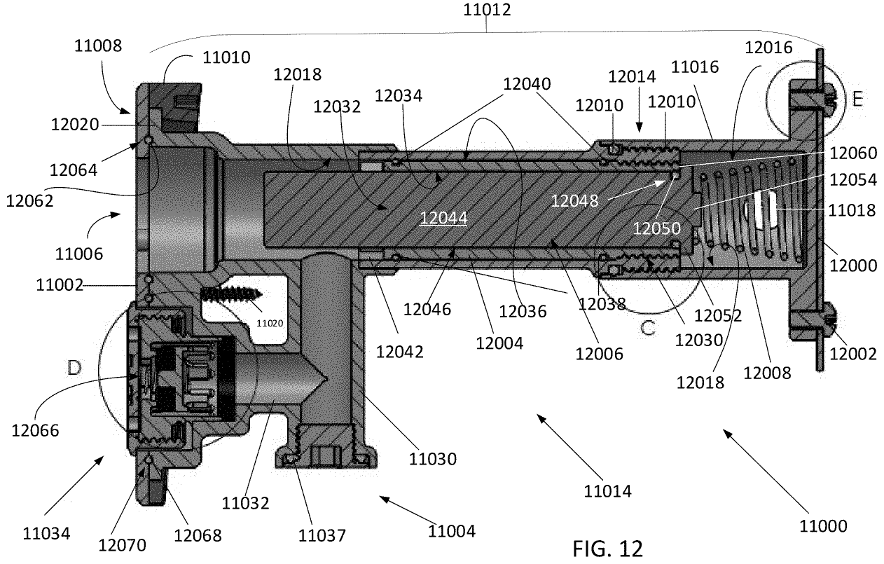

And the optional anti-siphon assembly 11004 includes respective vertical and horizontal hollow tubes 11030 and 11032, which are formed integrally with the front portion 11014 of the valve body 11012, an anti-siphon valve assembly 11034, and an optional threaded drain plug 11036 having a seal 11037 (see FIG. 12) such as an O-ring. As described below in conjunction with FIGS. 16A-16B, the anti-siphon assembly 11004 is configured to prevent water, or another substance, from entering a structure's water-supply-and-distribution system via the water valve 11000 and is also configured to allow water to drain from the tubes 11030 and 11032 while the water valve is closed. And because the anti-siphon assembly 11004 is disposed at the bottom, not the top, of the face-plate assembly 11008 and below the receptacle 11006, water discharged from the anti-siphon valve assembly 11034 does not drip over the upper portions of the face-plate assembly and over a water handle or other device (not shown in FIG. 11) engaged with the receptacle 11006.

In addition to the relatively low cost of the valve 11000 due to one or more components of the valve being made from one or more polymers, as described in more detail below, the valve is designed so that one or more components besides the body 11012 (and possibly the wedge 11010) can be replaced, repaired, or upgraded without first uninstalling the valve, for example, without first detaching the body from a structure in which the valve is installed and without disconnecting the valve from a water supply to which the valve is connected.

FIG. 12 is a cutaway side view of the valve 11000 of FIG. 11, according to an embodiment. In FIG. 12, the rear portion 11016 of the body 11012 is slightly different than in FIG. 11 in that the FIG. 12 version includes the inlet 11018 at a 90° angle into the page of the drawing, and the rear portion of the body includes a mounting bracket 12000 and mounting screws 12002 configured to attach the rear valve-body portion to the bracket, which is configured to mount to a stud or other portion or item of a structure in which the valve 11000 is, or is to be, installed.

In addition to the anti-siphon assembly 11004, the faceplate assembly 11008, the wedge 11010, the body 11012, and the mounting screws 11020, the valve 11000 includes a sleeve 12004, a flow-control rod 12006, and a rod-return spring 12008.

The rear portion 11016 of the body 11012 is attached to the front portion 11014 of the body via a threaded connection 12010, and a body seal 12012 (e.g., an O-ring) is configured to form a water-tight seal in a region 12014 where the rear and front body portions overlap.

The body 11012 includes a body cavity 12016 having an inner body-cavity wall or inner body-cavity surface 12018, a flange 12020, and countersink holes (not shown in FIG. 12), and the valve inlet 11018 of the body is configured for connection to a structure water supply via a conduit (not shown in FIG. 12). The countersink holes are configured to receive heads (not shown in FIG. 12) of the mounting screws 11020 so that the heads do not interfere with the faceplate 11002 mounting flush against the body flange 12020, which provides a portion of the body 11012 configured to receive the machine screws 11024 (FIG. 11). And the spring 12008 is configured with a tapered shape so that the back (the larger-diameter) end of the spring his held in place stably by the rear portion 11016 of the body 11012 (the back end of the spring has a diameter only slightly less than the inner diameter of the rear body portion to provide this stable holding of the spring).

The sleeve 12004 is configured to fit inside of the body cavity 12016 of the body 11012 and to be secured, removably, in place by a threaded connection 12030 with the body cavity 12016 inner surface 12018, but also is configured for removal from the body cavity to allow replacement, repair, or upgrade of itself or of other internal valve components such as the rod 12006 and the spring 12008. The sleeve 12004 includes a sleeve cavity 12032 having an inner cavity wall or cavity surface 12034, an outer sleeve wall or outer sleeve surface 12036, one or more sleeve-seal seats 12038 formed in the outer sleeve surface, and one or more sleeve seals 12040 disposed in the sleeve-seal seats. The sleeve seals 12040 are configured to form a fluid-tight seal (e.g., a water-tight seal) between the inner wall 12018 of the body cavity 12016 and the outer sleeve surface 12036 while the sleeve 12004 is properly installed inside of the body cavity. For example, the one or more sleeve seals 12040 may be conventional O-rings. The sleeve 12004 can be removed by unscrewing the sleeve from inside of the body cavity 12016 with a tool (not shown in FIG. 12) that engages slots 12042 on a front side of the sleeve.

The flow-control rod 12006 is configured for slidable disposition within the sleeve cavity 12032 so as to control a flow of water from the water supply, through the conduit (not shown in FIG. 12) from the water supply, the inlet 11018, the body cavity 12016, and the sleeve cavity, and out from the receptacle 11006 (and through, e.g., the handle cavity 5000 of the water handle 3000 of FIGS. 3-5). The flow-control rod 12006 includes a shaft 12044 having an outer surface 12046, a rod-seal seat 12048, a rod seal 12050 (e.g., a conventional O-ring) disposed in the rod-seal seat, a rod flange 12052 configured to limit the distance that the flow-control rod can travel toward the receptacle 11006, and a spring receptacle 12054 configured to receive a front end of the spring 12008.

Still referring to FIG. 12, the valve 11000 is shown in a closed position or state, that is, a state in which the flow-control rod 12006 is configured to, and does, prohibit water from flowing from the body cavity 12016 into to the sleeve cavity 12032. In the valve-closed state, the water pressure from the water supply connected to the valve 11000 is present in the body cavity 12016 via the conduit (not shown in FIG. 12) and the inlet 11018, and the spring 12008 is in a compressed state. The water pressure and the compressed spring 12008 act in concert to urge the flow-control rod 12006 away from a rear of the body cavity 12016—the rear of the body cavity is where the wider end of the spring 12008 is located—and toward the receptacle 11006. Consequently, the water pressure and the compressed spring 12008 force the rod seal 12050 into the sleeve cavity 12032 such that the rod seal forms a water-tight seal between the inner surface 12034 of the sleeve cavity 12032 and the outer surface 12046 of the flow-control rod 12006; the rod flange 12052 stops the water pressure and the compressed spring 12008 from pushing the flow-control rod out of the valve 11000 through the receptacle 11006. In an alternate embodiment, instead of being sized to form a water-tight seal between the sleeve-cavity inner surface 12034 and the rod outer surface 12046, the rod seal 12050 can have a larger diameter such that the rod seal forms a water-tight seal between the body cavity 12016 and an end 12060 of the sleeve 12004. Or the flow-control rod 12006 can have multiple rod seals 12048, one or more seals that are configured to form a water-tight seal between the sleeve-cavity inner surface 12034 and the rod outer surface 12046, and another seal that is configured to form a water-tight seal between the body cavity 12016 and the sleeve end 12060.

Still referring to FIG. 12, a seal 12062 (e.g., an O-ring) in a seal seat 12064 forms a water-tight seal between the abutting surfaces of the faceplate 11002 and the body flange 12020 around the receptacle 11006.

Furthermore, as described further below in conjunction with FIGS. 16A-16B, while the valve 11000 is closed, the anti-siphon assembly 11034 is open such that any water in the tubes 11030 and 11032 drains out of a front opening 12066 of the anti-siphon assembly.

Moreover, a seal 12068 (e.g., an O-ring) in a seal seat 12070 forms a water-tight seal between the abutting surfaces of the faceplate 11002 and a portion of the body flange 12020 around an opening configured to accept the anti-siphon assembly 11034.

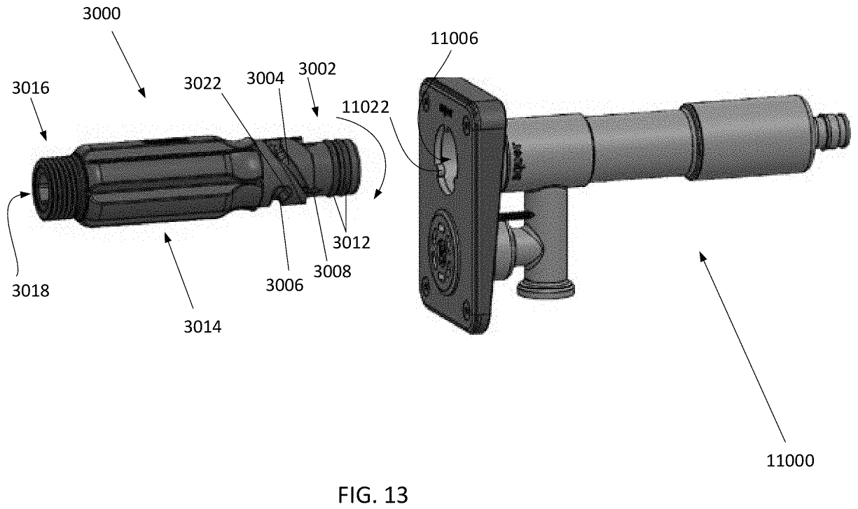

FIG. 13 is an exploded isometric view of the water valve 11000 of FIGS. 11-12 and of the water handle 3000, which is described above in conjunction with FIGS. 3-5, according to an embodiment. As described below, one can use the water handle 3000 to open the valve 11000 and to dispense water therefrom.

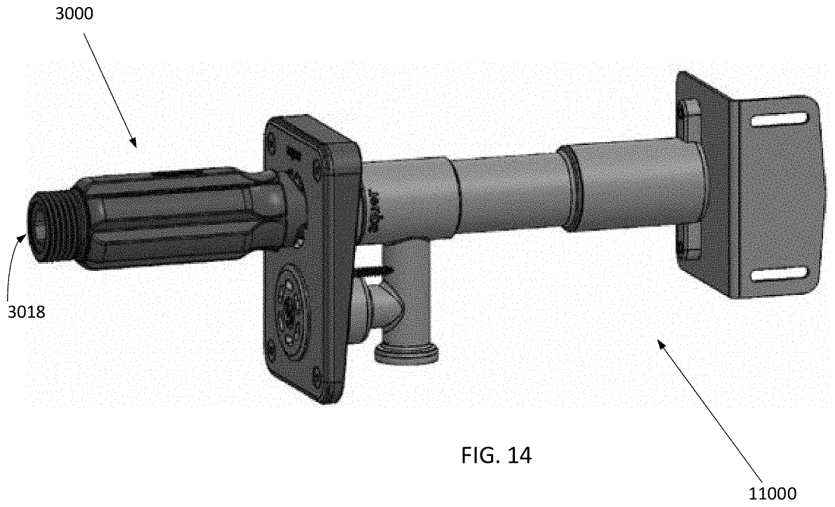

FIG. 14 is an isometric view of the water handle 3000 inserted in the water valve 11000, thus causing the water valve to be in an open state in which the water valve dispenses water from a water supply (not shown in FIG. 14) out through the dispensing port 3018 of the water handle 3000.

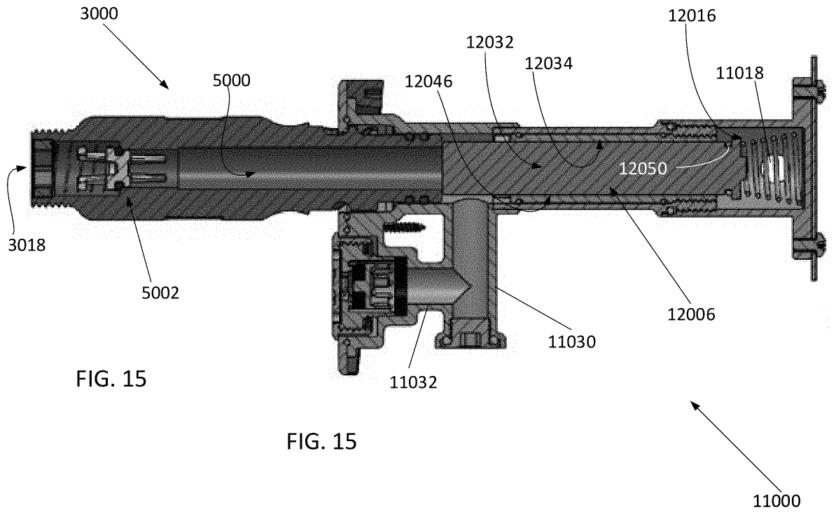

FIG. 15 is a cutaway side view of the water valve 11000 and the inserted handle 3000 of FIG. 14, where the inserted handle causes the water valve to be in an open state, according to an embodiment. The inserted handle 3000 forces the flow-control rod 12006 toward the rear of the body cavity 12016 and, therefore, forces the rod seal 12050 out from the sleeve cavity 12032. Forcing the rod seal 12050 out from the sleeve cavity 12032 breaks the water-tight seal that the rod seal previously formed between the inner surface 12034 of the sleeve cavity 12032 and the outer surface 12046 of the rod 12006, thus allowing water to flow from the water supply (not shown in FIG. 15) via the conduit (not shown in FIG. 15) and the inlet 11018, into the body cavity 12016, and out from the dispensing port 3018 of the handle 3000 via the sleeve cavity 12032 and the handle cavity 5000.

Referring to FIGS. 12-15, the opening and closing of the water valve 1000 is described, according to an embodiment.

First, a user grasps the water handle 3000 around the grasping section 3014.

Next, the user aligns the alignment arrow 3008 with one of the protrusions 11022.

Then, the user inserts the water handle 3000 into the receptacle 11006 until he encounters resistance.

Next, while continuing to push the water handle 3000 into the receptacle 11006, the user rotates the water handle in a clockwise direction. As the user so rotates the handle 3000, the protrusions 11022 and the grooves 3004 interact to convert the rotational torque being exerted by the user into a linear force that forces the handle further into the receptacle 11006 and into the sleeve cavity 12032 and then against a front side of the flow-control rod 12006.

Then, as the user continues to rotate the water handle 3000 in the clockwise direction, the protrusions 11022 and the grooves 3004 continue to interact to convert the rotational torque being exerted by the user into a linear force that overcomes the opposite force being exerted by the combination of the compressed spring 12008 and the water pressure in the body cavity 12016 and, therefore, that causes the handle to push the rod 12006 toward the rear of the body cavity 12016. Eventually, the handle 3000 pushes the rod 12006 far enough toward the rear of the body cavity 2010 that the rod seal 12050 slides out of the sleeve cavity 12032, thus breaking the water-tight seal between the inner surface 12034 of the sleeve cavity 12032 and the outer surface 12046 of the rod 12044.

After the handle 3000 is inserted far enough into the sleeve cavity 12032 to break the water-tight seal between the seal-cavity inner surface 12034 and the rod outer surface 12046, water flows from a water supply (not shown in FIGS. 12-15), through the conduit 2020 (FIG. 2) and the inlet 11018, into the body cavity 12016, from the body cavity into the sleeve cavity 12032, from the sleeve cavity into the handle cavity 5000, and from the handle cavity out from the handle dispensing port 3018—the pressure generated by the water flow is sufficient to open the check valve 5002.

The user then continues to rotate the handle 3000 in a clockwise direction until the protrusions 11022 engage the end wells 3006 of the grooves 3004, which end wells are configured such that the protrusions, when engaging the end wells, hold the handle stably within the open valve 11000 even after the user removes his hand from the gripping section 3014 (or any other portion) of the handle. After the user releases the handle 3000, the combined forces of the back water pressure and compressed spring 12008 urge the flow-control rod 12006, and, therefore, urge the handle 3000, back out from the sleeve cavity 12032 slightly, thus causing each of the protrusions 11022 to “lock” into a respective notch 3022 formed in a front portion of each end well 3006. This locking action holds the handle 3000 stably within the receptacle 11006 even in the presence of a relatively high-pressure water flow out of the dispensing port 3018. In an embodiment, the end wells 3006 and the notches 3022 are configured such that over a range of water pressures typically exerted by water sourced from a municipal water supply, the higher the water pressure the more forcefully and stably the handle 3000 is held within the receptacle 11006.

Still referring to FIGS. 12-15, to close the valve 3000, a user grasps the grasping section 3014 of the handle 3000, pushes the handle 3000 slightly further into the receptacle 11006 to disengage the protrusions 11022 from the end-well notches 3022, and rotates the handle in a counterclockwise direction.

As the user rotates the handle 3000 in the counterclockwise direction, the protrusions 11022 and the grooves 3004 interact to convert the rotational torque being exerted by the user into a linear force that forces the handle 3000 out from the sleeve cavity 12032. The water pressure and compressed spring 12008 urge the rod 12006 against the handle 3000, adding to the linear force being generated by the interaction of the protrusions 11022 and the grooves 3004 and, therefore, make the removal of the handle from the valve 11000 somewhat easier for the user than the insertion of the handle into the valve.

As the user continues to rotate the handle 3000 in the counterclockwise direction, the rod seal 12050 re-enters the sleeve cavity 12032 and re-establishes the water-tight seal between the inner surface 12034 of the sleeve cavity and the outer surface 12046 of the rod 12006.

As the user further continues to rotate the handle 3000 in the counterclockwise direction, the rod flange 12052 contacts the end 12060 of the sleeve 12004 and acts to prevent the flow-control rod 12006 from moving any further toward the receptacle 11006; consequently, from this point forward, the linear force urging the handle 3000 out of the receptacle 11006 is generated entirely by the interaction of the protrusions 11022 and the grooves 3004 as the user continues to rotate the handle in the counterclockwise direction.

And the user continues to rotate the handle 3000 in the counterclockwise direction until the grooves 3004 completely disengage from the protrusions 11022, at which point the user pulls the handle all the way out from the receptacle 11006.

As described above, the dual handle seals 3012 are configured to, and do, prevent pressurized water inside of the sleeve cavity 12032 from leaking around the sides of the handle front end 3002 and splashing, or otherwise wetting, the user while the user is removing the handle from the valve 11000. Furthermore, around the time that the rod seal 12050 re-establishes the water-tight seal between the sleeve-cavity surface 12034 and the rod surface 12046, the check valve 5002 closes to prevent back pressure in a conduit, such as a hose, or other item (not shown in FIGS. 2-5) attached to the handle rear end 3016 from causing water to squirt through the handle cavity 5000 and out from the handle front 3002 and possibly wet the user.

Descriptions of a valve similar to the valve 11000, and of the methods for opening and closing such a valve, are included in U.S. Pat. No. 11,242,673, which is incorporated by reference.

FIGS. 16A-16B are cutaway side views of the anti-siphon assembly 11034 of the water valve 11000 of FIGS. 11-15 in closed and open positions or configurations, respectively, according to an embodiment.

FIG. 16A is a cutaway side view of the anti-siphon assembly 11004 of FIGS. 11-15 with the valve assembly 11034 in closed position, according to an embodiment. The valve assembly 11034 includes threads 16000 and 16002, a valve base 16004, a fluid-(e.g., water-) stop gasket 16006, a sealing surface 16008, a return spring 16010, and the valve opening 12066. The threads 16000 engage threads 16014 of the anti-siphon tube 11032 to secure the valve assembly 11034 to the water valve 11000 (e.g., FIGS. 11-15). The anti-siphon assembly 11004 also includes a cover 16016 having threads 16018, which engage the threads 16002 to secure the cover to the valve assembly 11034. And the anti-siphon assembly 11004 includes a retainer 16020 to hold the gasket 16006 and spring 16010 in place. The anti-siphon assembly 11004, its valve assembly 11034, and their components can be formed from any suitable materials, such as a metal (e.g., stainless steel), a polymer (e.g., PVC), rubber (e.g., the gasket 16006 can be formed from rubber or a rubber-like material), and the like.

FIG. 16B is a cutaway side view of the anti-siphon assembly 11034 of FIGS. 11-15 with the anti-siphon valve assembly 11034 in an open position, according to an embodiment.

Referring to FIGS. 11— 16B, operation of the anti-siphon assembly 11004 is described, according to an embodiment.

In response to the water valve 11000 being opened, water fills the tubes 11030 and 11032. The pressure of the water generates a force sufficient to overcome the force of the spring 16010 such that the water pressure forces the water-stop gasket 16006 against the sealing surface 16008, and thus causes the gasket and sealing surface to form a watertight seal such that no water flows through the valve opening 12066 (see FIG. 12).

Under certain conditions, the water pressure in one or more of the body cavity 12016, the sleeve cavity 12032, or the handle cavity 5000 can suddenly and momentarily decrease. Such a decrease can be caused, for example, by the opening of one or more other valves (e.g., flushing a toilet) in the water-supply-and-distribution system to which the water valve 11000 is connected.

Without the anti-siphon assembly 11004, this pressure decrease could allow outside water from a reservoir to which the water valve 11000 is connected to enter, via the handle 3000 and the receptacle 11006, the water-supply-and-distribution system. Examples of such a reservoir can include a garden hose having an end coupled to the water valve 11000 and filled with water, or a swimming pool, spa, garden, or mud hole in which an opposite end of the garden hose is disposed. The entering of such outside water into the water-supply-and-distribution system is often undesired because such outside water can carry contaminants, such as dirt, bacteria and other infectious agents, or chemicals.

To prevent outside water from entering the water valve 11000, and, therefore, from entering the water-supply-and-distribution system to which the water valve is connected, in response to such a pressure drop, the anti-siphon valve assembly 11034 opens to equalize the pressure within one or more of the body cavity 12016, the sleeve cavity 12032, the handle cavity 5000, the tube 11030, or the tube 11032. During this momentary drop in pressure within these one or more cavities 12016, 12032, or 5000 or one or more tubes 11030 or 11032, the combined pressure of the air outside of the valve opening 12066 and force of the return spring 16010 generate a force that is sufficient to overcome the force generated by the dropped water pressure, and, therefore, that is sufficient to open the valve assembly 11034 by urging the gasket 16006 away from the sealing surface 16008 to break the watertight seal. In response to the breaking of the watertight seal, air flows through the valve opening 12066 to compensate for the momentary pressure drop inside of the one or more of the body cavity 12016, the sleeve cavity 12032, or the handle cavity 5000 or one or more of the tube 11030 or 11032 (i.e., to equalize the pressure inside of the water-supply-and-distribution system with the pressure outside of the water-supply-and-distribution system). This pressure compensation prevents outside water from flowing through the receptacle 11006 into the water-supply-and-distribution system. Another way to view the above-described operation is that the momentary drop in water pressure creates a suction that “sucks” in air through the valve assembly 11034 instead of “sucking” outside water in through the receptacle 11006.

As soon as the water pressure within the water-supply-and-distribution system increases back to normal (i.e., as soon as the pressure difference between the inside water and outside water is equalized), the water pressure in the one or more of body cavity 12016, the sleeve cavity 12032, or the handle cavity 5000 or one or more of the tubes 11030 or 11032 increases back to normal.

The increased water pressure generates a force sufficient to overcome the combined force of the spring 16010 and the air pressure outside of the valve opening 12066 such that the water pressure forces the water-stop gasket 16006 against the sealing surface 16008, and thus causes the gasket and sealing surface to re-establish a watertight seal such that no water or air flows through the valve opening.

The valve assembly 11034 is configured to repeat the above operation in response to one or more subsequent drops in water pressure within the water-supply-and-distribution system.

As described above, when the water valve 11000 is closed by removal of a device such as the water handle 3000, water remaining in one or more of the body cavity 12016, the sleeve cavity 12032, or the handle cavity 5000 drains out through the receptacle 11006 such that there is no water pressure in these cavities or in the tubes 11030 and 11032.

In response to the lack of water pressure, the return spring 16010 urges the water-stop gasket 16006 away from the sealing surface 16008 to break the watertight seal, and thus to open valve assembly 11034.

Therefore, any water remaining in the tubes 11030 or 11032 can drain through the valve opening 12066 such that there is little or no standing water in the tubes that could freeze and potentially damage the water valve 11000, or that otherwise could reduce the thermal protection that the water valve affords to the water-supply-and-distribution system to which it is connected.

Referring again to FIGS. 16A-16B, alternate embodiments of the anti-siphon system 11004 are contemplated. For example, the valve assembly 11034 can be secured to the tube 11032 by means (e.g., adhesive, welding) other than the threads 16000 and 16014.

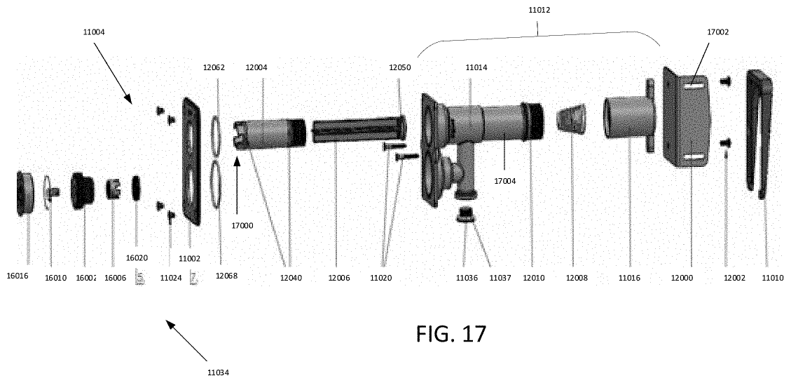

FIG. 17 is an exploded isometric view of the water valve 11000 of FIGS. 11-15, according to an embodiment. Because the faceplate assembly 11004 and the sleeve 12004 can be removed from the body 11012, all of the other (internal) components of the valve 11000, including the sleeve seal(s) 12040, the flow-control rod 12006, the rod seal(s) 12050, and the spring 12008 can be repaired, replaced, or upgraded without removing or detaching the valve body from the structure in which the valve body is installed. That is, there is no need to remove the mounting screws 11020 or to uncouple the conduit 2020 (FIG. 2) from the inlet 11018 (FIG. 15) to repair or upgrade the components of the valve 11000 other than the body 11012 or possibly the wedge 11010. And in an alternate embodiment, the wedge 11010 may have a cut in it so that it also can be replaced (by pulling apart the wedge at the cut and slipping the wedge over the valve body 11012) while the valve body remains installed in a structure. Furthermore, one or more of the mounting screws 11020 can be repaired, upgraded, or replaced without removing the valve body 11012 from the structure and without uncoupling the conduit 2020 (FIG. 2) from the inlet 11018. And to perform such a repair, upgrade, or replacement of components, typically it is recommended that the water supply be disconnected (e.g., with an in-line water shut off) from the valve 11000 before the sleeve 12004 is removed, although disconnecting the water supply is not required to effect repair, upgrade, or replacement of the valve components.

To remove the sleeve 12004 from the body 11012, one can insert a tool (not shown in FIG. 17) configured to engage a castle-like end 17000 of the sleeve, the castle-like end having notches and towers, and, after the tool engages the castle-like end of the sleeve, he then can unscrew the sleeve from the body (see the threaded connection 12030 of FIG. 12).

After the sleeve 12004 is removed from the body 11012, one can remove the flow-control rod 12006 and the spring 12008 from the body 11012 for replacement, repair, or upgrade. One can also remove and replace the sleeve seals 12040 and the rod seal 12050.

And without removing the sleeve 12004, one can remove and replace, repair, or upgrade one or more of the components 16002, 16006, 16010, 16016, and 16020 of the anti-siphon assembly 11034 of FIGS. 16A-16B by unscrewing the component 16002 from the front portion 11014 of the body 11012 using an appropriate tool.

Also, with removing the faceplate assembly 11004 but without removing the sleeve 12004, one can remove and replace one or both of the seals 12062 or 12068.

Furthermore, depending on the installation configuration, if one removes the faceplate assembly 11004 and the mounting screws 11020, he may be able to remove the front portion 11014 of the body 11012 from the rear portion 11016 of the body by unscrewing the front portion from the rear portion. Such removal would allow repair, replacement, or upgrade of one or more of the drain plug 11036, the seal 11037, the one or more body seals 12010, or the front body portion 11014 itself, without uninstalling the rear body portion 11016 or the bracket 12000.

In addition, slots 17002 in the mounting bracket 12000 allow one to adjust the position of the bracket even if the positions of the fasteners (e.g., screws, nails) that attach the bracket to a structure (e.g., to a stud of a house) are fixed.

Furthermore, a length of the valve body 11012 can be varied to suit the application of the valve 11000 by adjusting a length of a section 17004 of the front body section 11014. If the attachment (e.g., threaded-attachment) location of the sleeve 12004 within the body 11012 is shifted accordingly, and a spring stop for the spring 12008 is added at an appropriate location within the valve body, then the lengths of the sleeve 12004 and the rod 12006 need not be changed so that only one length sleeve and one length rod and one length spring need be manufactured, thus preventing an increase in manufacturing costs as compared to manufacturing multiple lengths of the sleeve and the rod and the spring. Alternatively, the length of the rear body section 11016 may be altered. And in another embodiment, instead of offering the valve body 11012 in multiple lengths, the inlet 11018 can be configured to stick straight out, or approximately straight out, from the back of the valve, and the valve can accommodate any wall thickness because one need only insert, into the wall, a section of conduit (e.g., PEX, not shown in FIG. 6) long enough to reach the inlet, whether the inlet be inside or outside of the wall.

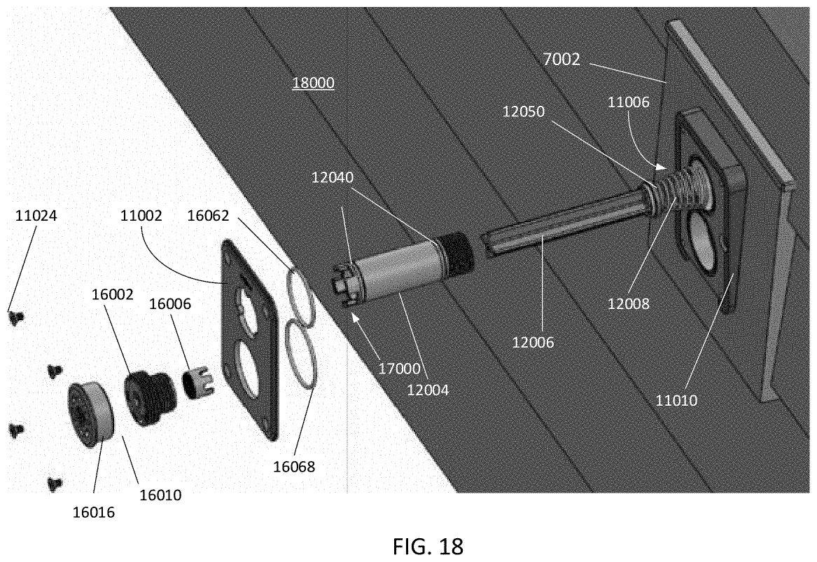

FIG. 18 is an exploded isometric view of a portion of the water valve 11000 of FIGS. 11-15 and 17 while the body 11012 of the water valve is installed in an exterior wall 18000 of a structure (e.g., a home, a commercial building, or another building or structure), according to an embodiment. Like FIGS. 12, 16, and 17, FIG. 18 shows that components of the water valve 11000 other than the valve body 11012 and possibly the wedge 11010 can be replaced, upgraded, or repaired without removing the valve body from the structure 18000. As described above in conjunction with FIG. 7, the mounting block 7002 may be used to facilitate installing the valve 11000 in the exterior wall 18000. For example, the mounting block 7002 may cover, in an aesthetically pleasing manner, a hole (not shown in FIG. 18) formed in the wall 18000 to receive the valve 11000. Furthermore, the valve 11000 can be installed in a structure other than an exterior wall of a building. For example, the valve 11000 can be installed in an interior wall, ceiling, or floor of a building, in a deck or other structure of a boat, in the ground, or can be embedded (e.g., without being wrapped) in a material such as concrete. Moreover, FIG. 18 demonstrates how the wedge 11010 angles the body 11012 downward, e.g., approximately 5°, so that water can drain out the receptacle 11006 while there is no water handle disposed in the receptacle.

Still referring to FIG. 18, a valve 11000 repair-upgrade-replacement kit can include one or more of the anti-siphon-assembly components 16002, 16006, 16010, or 16016, the faceplate 11002, the screws 11024, the seal 16062 or the seal 16068, the sleeve 12004, the sleeve seals 12040, the flow-control rod 12006, the rod seal 12050, the spring 12008, or a tool (not shown) configured for engaging the castle end 17000 of the sleeve and removing (by unscrewing) the sleeve from the valve body 11012 (not labeled in FIG. 18) to allow removal of the rod and spring. For example, in an embodiment, the kit can include the seals 16062, 16068, 12040, and 12050, the rod 12006, the spring 12008, and the sleeve-removal tool. In another embodiment, the kit can include the seals 16062, 16068, 12040, and 12050, the rod 12006, the spring 12008, the anti-siphon-assembly components 16002, 16006, 16010, and 16016, and the sleeve-removal tool. And in yet another embodiment, the kit can include the seals 16062, 16068, 12040, and 12050, the rod 12006, the spring 12008, the anti-siphon-assembly components 16002, 16006, 16010, and 16016, the faceplate 1102, the screws 11024, the mounting screws 11020 (FIG. 17), and the sleeve-removal tool.

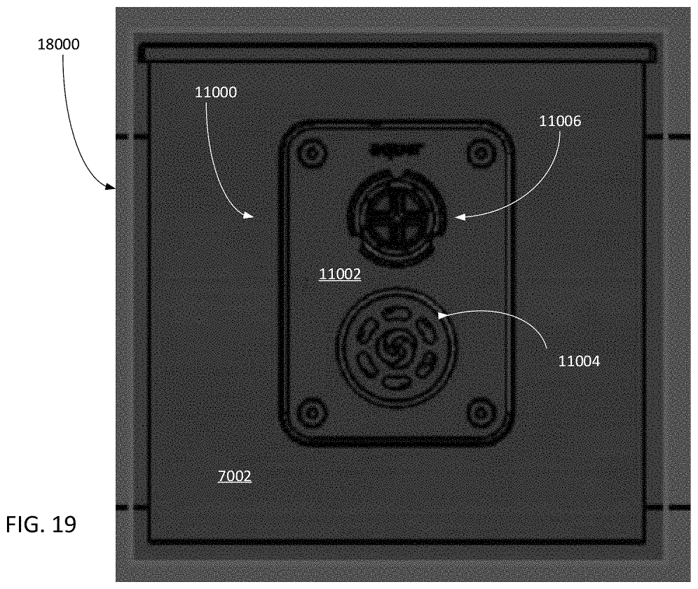

FIG. 19 is a front view of the water valve 11000 of FIGS. 11-15 and 17-18 installed in the exterior wall 18000 of a structure (e.g., a house or other building) with the mounting block 7002, according to an embodiment.

Referring to FIGS. 11-19, the on/off valve 10000 and the handle 10020 of FIGS. 10A, 10C, and 10D are usable with the valve 11000 in a manner similar to that described above in conjunction with the valve 1000. Furthermore, the inline anti-siphon assembly 10010 of FIG. 10C is usable with the valve 11000 in a manner similar to that described above in conjunction with the valve 1000, although use of the inline anti-siphon assembly may be redundant in embodiments of the valve 11000 including the anti-siphon assembly 11004.

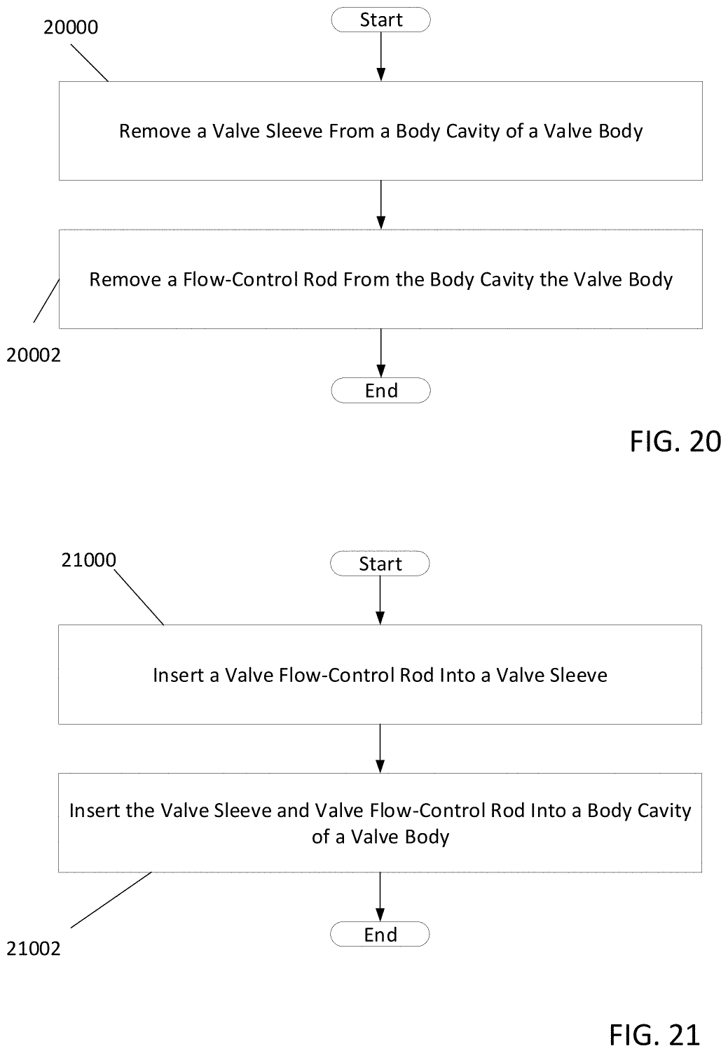

FIG. 20 is a flow diagram of a method for disassembling the water valve 1000 of FIGS. 1-9 and for disassembling the water valve 11000 of FIGS. 11-15 and 17-19, for example while a respective body 1008 or 11012 of the water valve is installed in a structure (e.g., a house or other building), according to an embodiment.

At 20000, one removes a sleeve 2000 (FIGS. 2 and 5-8) or a sleeve 12004 (FIGS. 12, 15, and 17-18) from a body cavity 2010 (FIG. 2) of a valve body 1008 (FIG. 2) or from a body cavity 12016 (FIG. 12) of a valve body 11012 (FIG. 12), respectively. During the removal of the sleeve 2000 or 12004, the valve body 1008 or 11012, respectively, may be installed in a structure such as a house or other building.

Then at 20002, one removes a flow-control rod 2002 (FIG. 2) or a flow-control rod 12006 (FIG. 12) from the body cavity 2010 (FIG. 2) or from the body cavity 12016 (FIG. 12), respectively. During the removal of the flow-control rod 2002 or 12004, respectively, the valve body 1008 or 12016, respectively, may be installed in a structure such as a house or other building.

Thereafter, one can repair, replace or upgrade one or more of the water-valve components such as (but not limited to) the sleeve 2000, sleeve seals 2034, flow-control rod 2002, rod seal 2040, or spring 2004 (FIG. 6), or the sleeve 12004, sleeve seals 12040, flow-control rod 12006, rod seal 12050, or spring 12008 (FIG. 17).

Furthermore, one may remove the sleeve 2000 and flow-control rod 12006, or the sleeve 12004 and the flow-control rod 12006, from the respective valve body 1008 or 11012, simultaneously. And the described method also applies to a valve 1000 or 11000 having a valve body that is not installed in a structure or elsewhere.

FIG. 21 is a flow diagram of a method for assembling the water valve 1000 of FIGS. 1-9 and for assembling the water valve 11000 of FIGS. 11-15 and 17-19, for example while a respective body 1008 or 11012 of the water valve is installed in a structure (e.g., a house or other building), according to an embodiment.

At 21000, one inserts a flow-control rod 2002 (FIG. 2) or a flow-control rod 12006 (FIG. 12) into a sleeve cavity 2026 of a sleeve 2000 (FIG. 2) or into a sleeve cavity 12032 of a sleeve 12004 (FIG. 12), respectively. During the insertion of the flow-control rod 2002 or 12006 into the sleeve 2000 or 12004, respectively, the valve body 1008 or 11012, respectively, may be installed in a structure such as a house or other building.

Then at 21002, one inserts the combination of the flow-control rod 2002 (FIG. 2) and sleeve 2000 (FIG. 2), or the combination of the flow-control rod 12006 (FIG. 12) and the sleeve 12004 (FIG. 12), into the body cavity 2010 (FIG. 2) of the body 1018 (FIG. 2) or into the body cavity 12016 (FIG. 12) of the body 11012, respectively. During the insertion of the flow-control rod 2002 and sleeve 2000 or flow-control rod 12006 and sleeve 12004, respectively, the valve body 1008 or 12016, respectively, may be installed in a structure such as a house or other building.

Before inserting the flow-control rod into the sleeve, or before inserting the combination of the flow-control rod and sleeve into the body cavity, one can repair, replace, or upgrade one or more of the water-valve components such as (but not limited to) the sleeve 2000, sleeve seals 2034, flow-control rod 2002, rod seal 2040, or spring 2004 (FIG. 6), or the sleeve 12004, sleeve seals 12040, flow-control rod 12006, rod seal 12050, or spring 12008 (FIG. 17).

The described method also applies to a valve 1000 or 11000 having a valve body that is not installed in a structure or elsewhere.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof. As described herein, any description relating to an example, embodiment, and/or figure merely illustrates an example technique, and is not intended to be limiting in its description; further, it is intended that elements of a example, embodiment, and/or figure, such one or more steps of a process, may be reordered, made optional, and/or combined with elements of other figures, and that a described process may be capable of including steps, particularly known steps, that are omitted from one or both of the description or a related flow diagram. Furthermore, as stated elsewhere, any apparatus described herein, such as a valve, or sub-apparatus described herein, such as an anti-siphon assembly, can have any one or more components formed from a polymer, or from a combination of polymers, where any one or more of such polymer components may be manufactured in a conventional manner such as by injection molding. Furthermore, the polymer or combination of polymers may be, or may not be, UV-damage resistant on a component-by-component basis.

What is claimed is:

1. A valve, comprising:
a body including a body cavity;
a sleeve removably disposable within the body cavity and including a sleeve cavity; and
a rod movably disposable within the sleeve cavity and configured to form a fluid-tight seal between the body cavity and the sleeve cavity while the rod is in a closed position and to allow a fluid to flow from the body cavity to the sleeve cavity while the rod is in an open position.

2. The valve of claim 1 wherein the body is configured for attachment to a structure having a fluid supply.

3. The valve of claim 1 wherein the body includes a flange configured for attachment to a structure having a fluid supply.

4. The valve of claim 1 wherein the body includes an inlet configured for coupling to a fluid supply and in fluid communication with the body cavity.

5. The valve of claim 1 wherein:
the body cavity includes an inner cavity wall; and
the sleeve includes an outer sleeve wall and is configured to form a fluid-tight seal between the inner cavity wall and the outer sleeve wall.

6. The valve of claim 1, further comprising:
wherein the body cavity includes an inner cavity wall;
wherein the sleeve includes an outer sleeve wall; and
at least one sleeve sealing ring disposable around the outer sleeve wall and configured to form a fluid-tight seal between the inner cavity wall and the outer sleeve wall.

7. The valve of claim 1, further comprising a spring disposable within the body cavity and configured to urge the rod toward the sleeve.

8. The valve of claim 1, further comprising:
wherein the body includes a flange; and
a faceplate configured for attachment to the flange and to hold the sleeve inside of the body cavity while the faceplate is attached to the flange.

9. The valve of claim 1 wherein:
the body cavity includes body-cavity threads; and
the sleeve includes sleeve threads that are configured to secure the sleeve within the body cavity by engaging the body-cavity threads.

10. The valve of claim 1, further comprising a wedge of non-uniform thickness disposable around an outside of the body.

11. The valve of claim 1 wherein at least one of the body, sleeve, or rod are formed from a polymer.

12. The valve of claim 1, further comprising a rod sealing ring disposable around the rod and configured to form the fluid-tight seal between the body cavity and the sleeve cavity while the rod is in a closed position.

13. The valve of claim 1, further comprising:
wherein the sleeve cavity includes an inner wall; and
a rod sealing ring disposable around the rod and configured to form the fluid-tight seal with the inner wall of the sleeve cavity while the rod is in a closed position.

14. The valve of claim 1, further comprising:
wherein the sleeve has a sleeve end; and
a rod sealing ring disposable around the rod and configured to form the fluid-tight seal with the sleeve end while the rod is in a closed position.

15. The valve of claim 1, further comprising:
wherein the rod includes a seat; and
a sealing ring disposable in the seat and configured to form the fluid-tight seal between the body cavity and the sleeve cavity while the rod is in a closed position.

16. The valve of claim 1, further comprising an anti-siphon assembly in fluid communication with at least one of the body cavity or the sleeve cavity.

17. The valve of claim 1, further comprising a faceplate attachable to the body, having a receptacle in fluid communication with at least one of the body cavity or the sleeve cavity, and including at least one protrusion each configured to engage a respective one of at least one groove of a valve-opening-and-fluid-dispensing device.

18. A structure, including:
an exterior;
a fluid supply; and
a valve attached to the exterior and coupled to the fluid supply, the valve including
a body including a body cavity,
a sleeve removably disposable within the body cavity and including a sleeve cavity, and
a rod movably disposable within the sleeve cavity and configured to form a fluid-tight seal between the body cavity and the sleeve cavity while the rod is in a closed position and to allow a fluid to flow from the body cavity to the sleeve cavity while the rod is in an open position.

19. The structure of claim 18 wherein the body is attached to the exterior.

20. The structure of claim 18 wherein the body includes a flange attached to the exterior.

21. The structure of claim 18 wherein the body includes an inlet configured for coupling to the fluid supply and in fluid communication with the body cavity.

22. A kit, comprising:
a sleeve removably disposable within a body cavity of a valve and having a sleeve cavity; and
a rod movably disposable within the sleeve cavity and configured to form a fluid-tight seal between the body cavity and the sleeve cavity while the rod is in a closed position and to allow a fluid to flow from the body cavity to the sleeve cavity while the rod is in an open position.

23. The kit of claim 22 wherein the sleeve includes an outer sleeve surface configured to form a fluid-tight seal between the outer sleeve surface and an inner surface of the body cavity.

24. The kit of claim 22, further comprising:
wherein the sleeve includes an outer sleeve surface; and
at least one sleeve sealing ring disposable around the outer sleeve surface and configured to form a fluid-tight seal between the outer sleeve surface and an inner surface of a body cavity.

25. The kit of claim 22, further comprising:
wherein the rod includes a flange;
wherein the sleeve includes an end; and
a spring disposable within the body cavity and configured to urge the flange against the end of the sleeve.

26. The kit of claim 22, further comprising a faceplate configured for attachment to the body to hold the sleeve inside of the body cavity while the faceplate is attached to the body.

27. The kit of claim 22 wherein the sleeve includes sleeve threads formed in an outer surface of the sleeve and configured to engage body threads formed in an inner surface of the body cavity.

28. The kit of claim 22 wherein at least one of the sleeve or the rod are formed from a polymer.

29. The kit of claim 22, further comprising:
wherein the sleeve cavity has an inner surface; and
a rod sealing ring disposable around the rod and configured to form the fluid-tight seal with the inner surface of the sleeve cavity while the rod is in a closed position.

30. The kit of claim 22, further comprising:
wherein the sleeve has a sleeve end; and
a rod sealing ring disposable around the rod and configured to form the fluid-tight seal with the sleeve end while the rod is in a closed position.

31. The kit of claim 22, further comprising at least one component of an anti-siphon assembly configured for fluid communication with at least one of the body cavity or the sleeve cavity.

32. The kit of claim 22, further comprising a faceplate attachable to the body, having a receptacle configured for fluid communication with at least one of the body cavity or the sleeve cavity, and including at least one protrusion each configured to engage a respective one of at least one groove of a valve-opening-and-fluid-dispensing device.

33. A method, comprising:
removing a valve sleeve from a body cavity of a valve body while the valve body is attached to a structure and is coupled to a fluid supply; and
removing a valve rod from the body cavity.

34. The method of claim 33 wherein removing the valve sleeve comprises detaching a valve faceplate from the valve body before removing the valve sleeve.

35. The method of claim 33 wherein removing the valve sleeve includes removing the valve sleeve with a tool.

36. The method of claim 33 wherein removing the valve sleeve includes rotating the valve sleeve to disengage threads of the valve sleeve from threads of the body cavity.

37. The method of claim 33, further comprising removing the valve rod from the valve sleeve.

38. The method of claim 33, further comprising removing at least one seal ring from around the valve sleeve.

39. The method of claim 33, further comprising removing at least one seal ring from the valve rod.

40. The method of claim 33, further comprising removing a spring from the body cavity.

41. A method, comprising:
inserting a valve rod into a valve sleeve; and
inserting the valve sleeve and valve rod into a body cavity of a valve body while the valve body is attached to a structure and is coupled to a fluid supply.

42. The method of claim 41, further comprising attaching a valve faceplate to the valve body after inserting the valve sleeve and valve rod into the body cavity of the valve body.

43. The method of claim 41, further comprising securing the valve sleeve in the body cavity with a tool.

44. The method of claim 41, further comprising securing the valve sleeve in the body cavity by rotating the valve sleeve to engage threads of the valve sleeve with threads of the body cavity.

45. The method of claim 41, further comprising installing at least one seal ring around the valve sleeve before inserting the valve sleeve into the body cavity.

46. The method of claim 41, further comprising installing at least one seal ring on the valve rod before inserting the valve rod into the body cavity.

47. The method of claim 41, further comprising inserting a spring into the body cavity before inserting the valve sleeve and the valve rod into the body cavity.
